(19) United States
(12) Patent Application Publication
(10) Pub. No.: US 2011/0037239 A1
(43) Pub. Date: Feb. 17, 2011

(54) STABILIZER DEVICE

(76) Inventors: Shunsuke Mori, Yokohama-shi (JP); Takayasu Sakashita, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/844,187

(22) Filed: Jul. 27, 2010

(30) Foreign Application Priority Data
Jul. 31, 2009 (JP) 179707/2009
Nov. 30, 2009 (JP) 271822/2009

(51) Int. Cl. B60G 21/055

(52) U.S. Cl. 280/124.106

(57) ABSTRACT

A stabilizer device according to the present invention includes a first stabilizer bar, a second stabilizer bar, and a variable rigidity unit coupling the stabilizer bars and adjusting torsion rigidity. The variable rigidity unit includes a linear motion mechanism adapted to perform a linear motion according to a relative rotation between the first stabilizer bar and the second stabilizer bar, a biasing mechanism for biasing the linear motion mechanism in a direction for preventing the linear motion, and a biasing force adjustment mechanism for adjusting a biasing force of the biasing mechanism.

### BACKGROUND OF THE INVENTION

The present invention relates to a device equipped with a linear motion mechanism that is mounted on a vehicle such as an automobile, and a stabilizer device preferably for use in a reduction in a roll motion of a vehicle body.

Some vehicles such as an automobile are equipped with a stabilizer device for stabilizing the posture of the vehicle body when the vehicle is in, for example, a cornering running condition. In recent years, an easily mountable electric stabilizer device has been developed, in addition to a conventionally developed hydraulic stabilizer device. Japanese Patent Public Disclosure 2008-120175 discloses an example of an electric stabilizer device.

Such a stabilizer device is mounted on a vehicle, and is used to improve the traveling performance of the vehicle. It is desirable to reduce a space in a vehicle that is required for mounting of a stabilizer device, whereby there are demands for miniaturization of a stabilizer device.

### SUMMARY OF THE INVENTION

An object of the present invention is to provide a stabilizer device capable of achieving the above-mentioned object.

To achieve the forgoing and other objects, the present invention provides a stabilizer device comprising a first stabilizer bar, a second stabilizer bar, and a variable rigidity unit coupling the stabilizer bars and adjusting torsion rigidity. The variable rigidity unit comprises a linear motion mechanism adapted to perform a linear motion according to a relative rotation between the first stabilizer bar and the second stabilizer bar, a biasing mechanism for biasing the linear motion mechanism in a direction for preventing the linear motion, and a biasing force adjustment mechanism for adjusting a biasing force of the biasing mechanism.

### BRIEF DESCRIPTION OF THE DRAWINGS

FIG. 1 is a system diagram illustrating an example of an overall configuration of a vehicle using a stabilizer device;

FIG. 2 is a vertical cross-sectional diagram illustrating a stabilizer device according to a first embodiment of the present invention;

FIG. 3 is a vertical cross-sectional diagram illustrating the stabilizer device shown in FIG. 2 when an initial load of a coil spring is increased;

FIG. 4 is an exploded perspective diagram illustrating the stabilizer device;

FIG. 5 is an enlarged cross-sectional diagram of main parts, illustrating conversion of a relative rotation between plates into a linear motion by first and second ramps and a ball;

FIG. 6 is a schematic diagram illustrating the relationship between a torque and a torsion angle between stabilizer bars;

FIG. 7 is a vertical cross-sectional diagram illustrating a stabilizer device according to a second embodiment of the present invention;

FIG. 8 is a vertical cross-sectional diagram illustrating a stabilizer device according to a third embodiment of the present invention;

FIG. 9 is a vertical cross-sectional diagram illustrating a stabilizer device according to a fourth embodiment of the present invention;

FIG. 10 is an enlarged cross-sectional diagram of main parts, illustrating a ramp according to a first variation of the present invention;

FIG. 11 is an enlarged cross-sectional diagram of main parts, illustrating a ramp according to a second variation of the present invention;

FIG. 12 is a block diagram illustrating a circuit configuration of a control device;

FIG. 13 is a vertical cross-sectional diagram illustrating a stabilizer device according to a fifth embodiment of the present invention;

FIG. 14 is an exploded perspective diagram illustrating the stabilizer device; and

FIG. 15 is an enlarged cross-sectional diagram of a rotation prevention mechanism as viewed from the direction indicated by the arrow IV in shown FIG. 13.

### DETAILED DESCRIPTION OF THE INVENTION

The stabilizer device which will be described herein is capable of achieving various objects desired for commercialization of a stabilizer device. The stabilizer device can achieve not only the above-mentioned miniaturization but also the objects which will be described below. The major ones of them are now described below.

“Further Miniaturization”

The embodiments of the present invention can change the rigidity between stabilizer bars of the stabilizer device. For fulfilling this purpose, the stabilizer device includes a variable rigidity unit enabling adjustment of the torsion rigidity between a pair of stabilizer bars.

More specifically, the variable rigidity unit includes a linear motion mechanism adapted to linearly move according to a relative rotation between a first stabilizer bar and a second stabilizer bar, a biasing mechanism adapted to apply a biasing force in the direction for preventing the linear motion, and a biasing force adjusting mechanism adapted to adjust the biasing force of the biasing mechanism.

More specifically, the embodiments employ a mechanism sandwiching balls or conical rollers between two plates having inclinations as the linear motion mechanism (herein after referred to as “ball and ramp mechanism”), an elastic spring member constituted by, for example, a coil spring or a disc spring as the biasing mechanism, and the mechanism for adjusting the elastic force, i.e., biasing force of the spring member.

As mentioned above, the embodiments which will be described later include the ball and ramp mechanism and the mechanism for controlling a pressing force applied to the ball and ramp mechanism, and thereby can control the rigidity characteristic of the stabilizer with use of these mechanisms. The above-mentioned structure is effective to realize the miniaturization of the stabilizer device.

Further, due to the arrangement of the elasticity controlling mechanism inside the force application mechanism providing a pressing force to the ball and ramp mechanism, a space inside the stabilizer device can be efficiently utilized, resulting in realization of the miniaturization. In the embodiment which will be described later, the elasticity controlling mechanism is a mechanism which adjusts an elastic coefficient of the spring by adjusting the length of the spring.

“Simplification of Device”

The embodiments of the present invention has a simplified structure constituted by the ball and ramp mechanism including the balls, and the ramp grooves which sandwich the balls and serve as inclinations, and the mechanism applying a pressing force to the ball and ramp mechanism by changing the spring length. This structure can cut down the cost, or improve the productivity. Further, the simplification of the structure of the device brings about a long operating life.

Further, the housing for containing the force application mechanism for applying a pressing force to the ball and ramp mechanism is also used as a member for transmitting the torsion force, resulting in further simplification of the device.

“Reduction in Electricity Consumption”

The embodiments of the present invention employ a trapezoidal screw having low reverse operability. Therefore, for example, even when there are successively alternately left corners and right corners, since the trapezoidal screw is retained at a controlled position and therefore electricity supplied to the motor can be stopped or reduced, it is possible to reduce electricity consumption. That is, the embodiments which will be described later are configured such that a rotation of the electric motor is converted into a linear motion by the linear motion conversion mechanism to control the length of the biasing means to change the elastic force, thereby to adjust the torsion rigidity between the first and second stabilizer bars. For maintaining the torsion rigidity, the length of the biasing means is maintained with the aid of a mechanical frictional force of the linear motion conversion mechanism. Therefore, the adjusted torsion rigidity can be maintained with use of little of a torque of the electric motor or without use of a torque of the electric motor at all. A large amount of electricity is supplied to the electric motor when the torsion rigidity should be adjusted, but a supply of a large amount of electricity is not necessary for maintaining the torsion rigidity. Therefore, the embodiments of the present invention can realize the electricity consumption reduction effect. The structure with use of a mechanical frictional force is characterized in two aspects. First, a trapezoidal screw is employed for the linear motion conversion mechanism. Secondly, the inclination of the groove relative to the shaft of the screw of the linear motion conversion mechanism is small so that an axial travel amount is small relative to a rotation amount. Due to these characteristic features, it is possible to realize the biasing force maintaining function as mentioned above, and in addition, miniaturize the electric motor due to a reduction in a rotational torque to be generated by the electric motor.

“Improvement of Ride Comfort”

A stabilizer device is desired to be configured such that a ride comfort is not affected by reducing the spring constant in the range where the torsion angle is small, while in the range where the torsion angle is large, for example, when a vehicle turns a corner, a roll motion when the vehicle turns the corner is reduced by increasing the spring constant to increase the biasing force. Such adjustment of the rigidity in the respective ranges can be easily realized by the embodiment which will be described later. Further, one important object is to reduce uncomfortable feeling at the time of switching the spring constant. The embodiments which will be described later can change the spring constant in a desired manner by adjusting the profile of the ramp groove of the ball and ramp mechanism. That is, the desired rigidity characteristic of a stabilizer can be obtained by changing the shape of the ramp groove of the ball and ramp mechanism. This leads to the effect of improving a ride comfort of a vehicle.

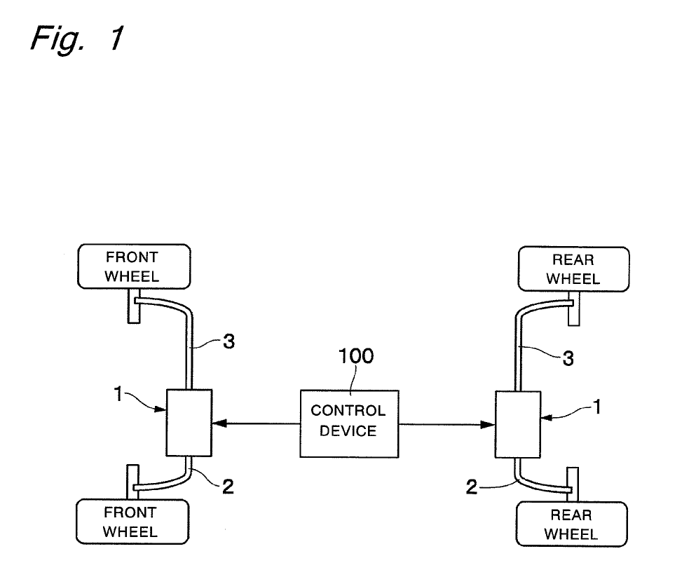

FIG. 1 illustrates an overall configuration of a vehicle having a front wheel side and a rear wheel side each employing a stabilizer device 1. When the vehicle travels around a corner and a force in the roll direction is applied to the vehicle, each of the stabilizer devices 1 disposed on the front and rear sides operates to reduce a roll motion of the vehicle based on a control signal from a control device 100. Due to the stabilizer devices, it is possible to prevent lateral turning of the vehicle, improve control stability, or improve a ride comfort.

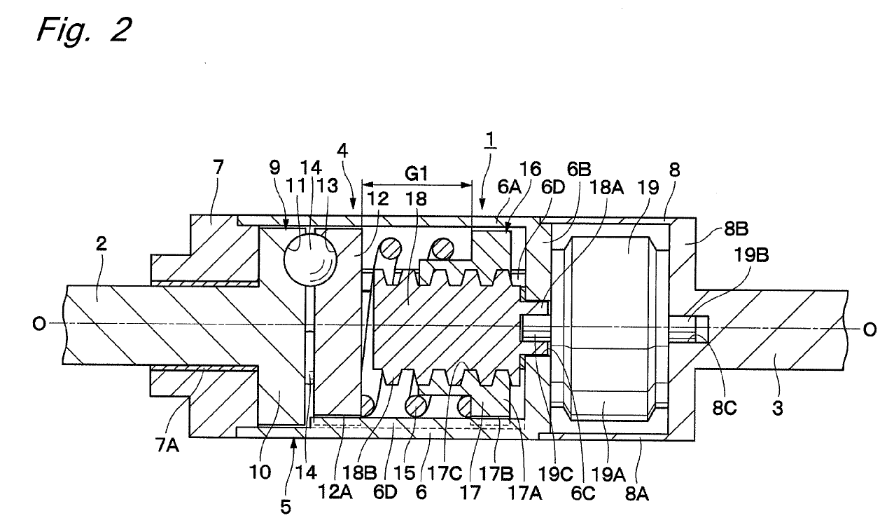

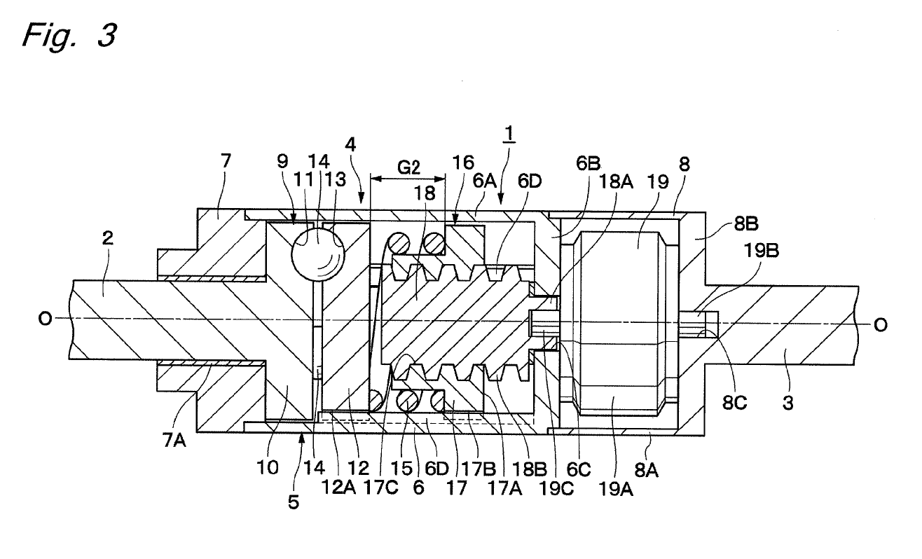

FIGS. 2 and 3 illustrate a first embodiment of the present invention. The central portion of the stabilizer device 1 in the longitudinal direction thereof is attached to a vehicle body side which constitutes the vehicle, and the both ends of the stabilizer device 1 are respectively connected to the left and right wheel sides, as shown in FIG. 1. Further, the stabilizer device 1 comprises a first stabilizer bar 2, a second stabilizer bar 3, and a variable rigidity unit 4 for connecting the stabilizer bars 2 and 3 and adjusting the torsion rigidity between the stabilizer bars 2 and 3.

The first stabilizer bar 2 located on the left side of the vehicle body is made from a flexible spring steel, and is bent into a desired shape according to, for example, a layout of the vehicle body, as shown in FIG. 1. The proximal end side of the first stabilizer bar 2 is coupled to the second stabilizer bar 3 through the variable rigidity unit 4, and the distal end side thereof is connected to the left wheel side. Further, the proximal end side of the first stabilizer bar 2 is connected to a ball and ramp mechanism 9 which serves as a mechanism for transmitting a torsion motion to each other (hereinafter referred to “linear motion mechanism”) while being affected by torsion rigidity. The first stabilizer bar 2 is mechanically connected to one end of the ball and ramp mechanism 9, and the second stabilizer bar 3 is mechanically connected to the other end of the ball and ramp mechanism 9. The ball and ramp mechanism 9 is mere an example of the linear motion mechanism, and comprises a first plate 10, a second plate 12, and balls 14. A thrust force based on a biasing mechanism is applied to the first plate 10 and the second plate 12. The balls 14 are pressed against ramp grooves respectively formed at the first plate 10 and the second plate 12 by the thrust force, and the torque transmission coefficient is adjusted based on the thrust force and the shape of the grooves.

The second stabilizer bar 3 located at the right side of the vehicle body is made from a flexible spring steel, substantially similarly to the first stabilizer bar 2, and is bent into a shape substantially symmetrical to the first stabilizer bar 2 as shown in FIG. 1. The proximal end side of the second stabilizer bar 3 is connected to the first stabilizer bar 2 through the variable rigidity portion 4, and the distal end side thereof is connected to the right wheel side. Further, the proximal end side of the second stabilizer bar 3 is mechanically connected to a motor case 8 of a casing 5 which will be described later. In the present embodiment, the first stabilizer bar 2 and the second stabilizer bar 3 may be less flexible, and may be made from, in addition to metal, a glass fiber or a carbon fiber for reducing the weight thereof.

The first stabilizer bar 2 and the second stabilizer bar 3 are supported in such a manner that the proximal end sides of the first and second stabilizer bars 2 and 3 are located on an axis O-O, and the first and second stabilizer bars 2 and 3 can be rotated in the vertical direction as shown in FIG. 2 about the axis O-O relative to the vehicle body side.

The variable rigidity unit 4 coupling the first and second stabilizer bars 2 and 3 adjusts the torsion rigidity between the first and second stabilizer bars 2 and 3. Further, the variable rigidity unit 4 comprises the casing 5, the ball and ramp mechanism 9, a coil spring 15, and a biasing force adjustment mechanism 16. The coil spring may be replaced by a disc spring.

The casing 5 defining the outer contour of the variable rigidity unit 4 is configured as a cylindrical container axially extendable and compressible along the axis O-O. Further, the casing 5 is made from a sufficiently rigid material such as metal material, and comprises a plate case 6, a cover body 7, and the motor case 8. The casing 5 serves as not only a container for containing the ball and ramp mechanism 9 serving as the linear motion mechanism, and the biasing mechanism for providing a thrust force to the linear motion mechanism, but also a transmission member for transmitting a torsion force, i.e., a torque. This arrangement leads to the advantageous effect of simplification of the stabilizer structure. In the present embodiment, the biasing mechanism comprises the coil spring 15 for generating a biasing force, and a linear motion conversion mechanism for adjusting the axial length of the coil spring 15. The linear motion conversion mechanism includes a screw 17C and a screw 18B.

On the other hand, the cover body 7 has a stepped cylindrical shape, and is integrally fixedly attached to the left end of a cylindrical portion 6A to close it. Further, a slide bearing 7A is disposed on the inner circumferential side of the cover body 7 for rotatably supporting the proximal end side of the first stabilizer bar 2.

The motor case 8 disposed at the right side of the plate case 6 contains an electric motor 19 which will be described later, and is formed into a bottomed cylindrical shape constituted by a cylinder portion 8A and a bottom portion 8B. Further, the opening side of the cylindrical portion 8A is integrally fixedly attached to the outer circumferential side of the bottom portion 6B of the plate case 6. The bottom portion 8B has a shaft fixation hole 8C formed at the center thereof, into which a fixation shaft 19B of the electric motor 19 is non-rotatably fittedly inserted. The center portion of the bottom portion 8B is integrally connected to the proximal end of the second stabilizer bar 3, whereby the casing 5 can rotate with the second stabilizer 3 relative to the first stabilizer bar 2.

The ball and ramp mechanism 9, which is contained in the left side of the plate case 6 and serves as the linear motion mechanism, performs a linear motion according to a relative rotation between the first stabilizer bar 2 and the casing 5 mechanically connected to the second stabilizer bar 3, and more specifically, adjusts the transmission coefficient based on the shape of the ramp thereof. The ball and ramp mechanism 9 functions to adjust the rigidity characteristic of the stabilizer device. The thrust force generated by the linear motion and the thrust force generated by the biasing means are balanced by converting the relative rotation phase difference into a linear motion and adding the thrust force along the axial direction of the linear motion by the biasing means, and the transmission coefficient is determined from the balance position. In particular, the linear motion mechanism is embodied by the ball and ramp mechanism 9. The ball and ramp mechanism 9 is generally constituted by the first plate 10, the second plate 12, and balls 14 disposed between the first plate 10 and the second plate 12.

As shown in FIGS. 2 to 4, the first plate 10 disposed in the left side of the plate case 6 shown in FIG. 2 is formed into a thick circular disk the center of which is located on the axis O-O. The center portion of the left end surface of the first plate 10 is integrally connected to the proximal end of the first stabilizer bar 2, whereby the first plate 10 can rotate with the first stabilizer bar 2 relative to the second stabilizer bar 3. Further, a plurality of first ramps 11, for example, three first ramps 11 as first inclinations are formed in a circumferentially extending manner at the right end surface (front surface) of the first plate 10.

Each ramp 11 is formed into a curved shape like a circular arc. Each ramp 11 has the deepest portion at the center in the extending direction thereof (the circumferential direction of the plates 10 and 12), and is formed into a circular arc groove, defining the inclination the depth of which is gradually reduced from the deepest portion to the both end sides according to a predetermined curvature. Further, it is desirable that the shapes from the center to the both ends are symmetrical about the center.

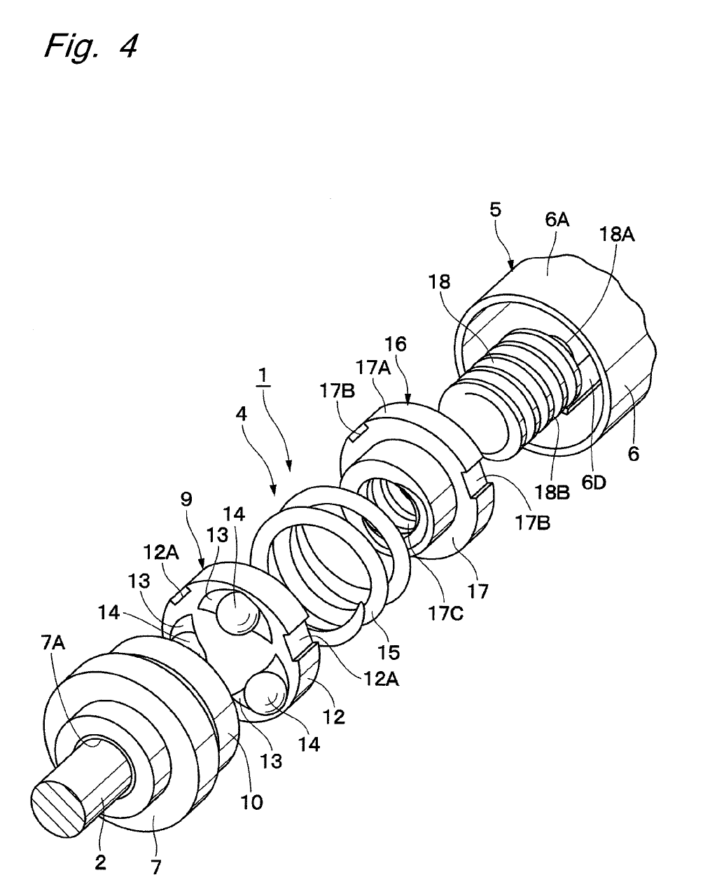

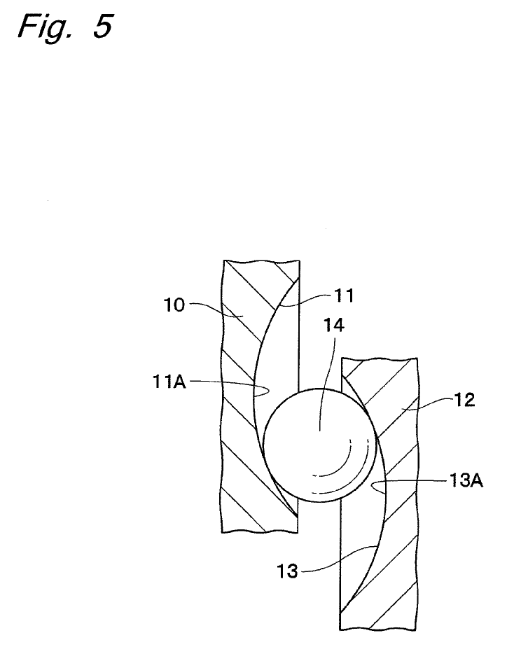

The second plate 12 disposed to face the right side of the first plate 10 is formed into a thick circular disk the center of which is located on the axis O-O, substantially similarly to the first plate 10. As shown in FIG. 4, three engagement grooves 12A are substantially equiangularly formed at the outer circumferential surface of the second plate 12, and the respective engagement grooves 12A are engaged with respective protrusions 6D formed on the inner wall of the plate case 6. Due to this engagement, the second plate 12 is non-rotatably coupled with the second stabilizer bar 3 through the casing 5.

Further, three second ramps 13 as second inclinations are formed on the left side surface (front surface) of the second plate 12 which faces the first plate 10. Substantially similarly to the first ramp 11, each of the three ramps 13 is formed into a curved shape like a circular arc. Each ramp 13 has the deepest portion at the center in the extending direction thereof, and is formed into a circular arc groove, defining the inclination the depth of which is gradually reduced from the deepest portion to the both end sides. This curved shape aids in adjusting a ride comfort of the vehicle. It is desirable to reduce influence on a ride comfort by reducing the spring constant in the range where the torsion angle is small, and to reduce a roll motion at the time of cornering by increasing the spring constant in the range where the torsion angle is large. To create this desirable arrangement, the circular arc has a large curvature radius (reduced curvature) so as not to generate a torsion force in the range of small torsion angle, and has a small curvature radius (increased curvature) so as to rapidly increase a torque in the range of large torsion angle. This nonlinear characteristic can be adjusted by the shape of the groove. Alternately, the profile of the groove may be determined according to a desired characteristic by, for example, a linear shape or a combination of a linear shape and a curved shape.

The three balls 14 sandwiched between the first plate 10 and the second plate 12 are contained in the first ramps 11 and the second ramps 13. Further, each ball 14 is formed as, for example, a metal ball having a diameter dimension sized to prevent abutment between the plates 10 and 12 when the ball 14 is contained in the ramps 11 and 13.

The ball and ramp mechanism 9 configured in this way is biased so that the balls 14 are disposed at the deepest portions of the ramps 11 and 13, i.e., the plates 10 and 12 become spaced apart by a smallest distance L₁ by pressing the first plate 10 and the second plate 12 against each other by means of the biasing force of the coil spring 15 which will be described later. As a result, the first stabilizer bar 2 and the second stabilizer bar 3 are biased to be constantly at an initial angle (the angle not causing an inclination of the vehicle).

On the other hand, when a relative rotation is generated between the first stabilizer bar 2, and the second stabilizer bar 3 and the casing 5 about the axis O-O, the balls 14 are moved to the end sides of the first ramps 11 and second ramps 13 since the first ramps 11 and the second ramps 13 are circumferentially out of alignment with each other. These movements of the balls 14 cause the plates 10 and 12 to be spaced apart by a distance dimension L₂, which is longer than the distance dimension L₁ by an amount corresponding to the protrusions of the balls 14 from the ramps 11 and 13. In this case, increasing the biasing force of the coil spring 15 pressing the second ramp 13 toward the first ramp 11 can increase the torsion rigidity at this time.

The coil spring 15, as the biasing mechanism disposed at the right side of the second plate 12 and contained in the plate case 6, biases the second plate 12 in the direction for preventing a linear motion of the second plate 12, and is constituted by an elastic member generating a pressing force for pressing the second plate 12 toward the first plate 11. Employment of a coil spring as an elastic member enables the elastic member to be formed from one member, and improves assemblability compared to, for example, employment of a disc spring.

The biasing force adjustment mechanism 16, which is disposed in the casing 5 for adjusting the biasing force of the coil spring 15, is configured as a load application unit for applying an arbitrarily-adjusted initial load in the extension/compression direction of the coil spring 15. Further, the biasing force adjustment mechanism 16 is generally constituted by a piston 17 disposed in the plate case 6 as which will be described later, a screw member 18, and the electric motor 19 disposed in the motor case 8. The electric motor 19 is contained in the motor case 8, and is disposed so as to be aligned with the ball and ramp mechanism 9 and the biasing force adjustment mechanism 16 in the axial direction, but may be arranged in parallel with the biasing force adjustment mechanism in case that the axial length is limited.

The piston 17, which is disposed to face the second plate 12 so as to sandwich the coil spring 15 between the piston 17 and the second plate 12, is formed into a stepped cylindrical shape. Further, as shown in, for example, FIGS. 2 and 4, the piston 17 includes a large-diameter spring retainer 17A, and three engagement grooves 17B equiangularly formed on the outer circumferential surface of the spring retainer 17A. The respective engagement grooves 17B are engaged with the respective protrusions 6D of the plate case 6. Due to this engagement, the piston 17 is coupled in such a manner that the piston 17 is axially movable while being prevented from rotating relative to the casing 5.

Further, a female screw 17C such as a trapezoidal screw is formed on the inner circumferential side of the piston 17. The female screw 17C, along with a male screw 18B of the screw member 18 which will be described later, constitutes a screw mechanism for converting a rotation of the electric motor 19 which will be described later into a linear motion of the piston 17.

The screw member 18 disposed on the inner circumferential side of the piston 17 is attached at a shaft attachment portion 18A at the proximal side thereof to an output shaft 19C of the electric motor 19 which will be described later. Further, the male screw 18B such as a trapezoidal screw screwed with the female screw 17C of the piston 17 is formed on the outer circumference of the screw member 18. The male screw 18B and the female screw 17C constitute the screw mechanism together.

The electric motor 19 as a rotation actuator is disposed in the motor case 8. This electric motor 19 is generally constituted by a main body 19A containing, for example, a stator and a rotator (both are not shown), a fixation shaft 19B protruding from the right end of the main body 19A and non-rotatably fittedly inserted in the shaft fixation hole 8C of the motor case 8, and an output shaft 19C protruding from the left end of the main body 19A and connected to the rotator. Further, the output shaft 19C is fittedly inserted in the shaft attachment portion 18A of the screw member 18 within the shaft insertion hole 6C of the plate case 6 in such a manner that the output shaft 19C integrally rotates with the screw attachment portion 18A.

As shown in FIG. 2, in the biasing force adjustment mechanism 16 configured in this way, the initial load to the coil spring 15 is determined based on a distance dimension G₁ between the second plate 12 and the spring retainer 17A of the piston 17. As shown in FIG. 3, driving the screw member 18 to rotate by the electric motor 19, and linearly move the piston 17 toward the second plate 12 enables the distance dimension between the second plate 12 and the spring retainer 17A of the piston 17 to be reduced to the smaller dimension G₂, and thereby the initial load of the coil spring 15 to be adjusted to the large load side. On the other hand, driving the screw member 18 to rotate in the reverse direction by the electric motor 19 enables the initial load of the coil spring 15 to be adjusted to the small load side.

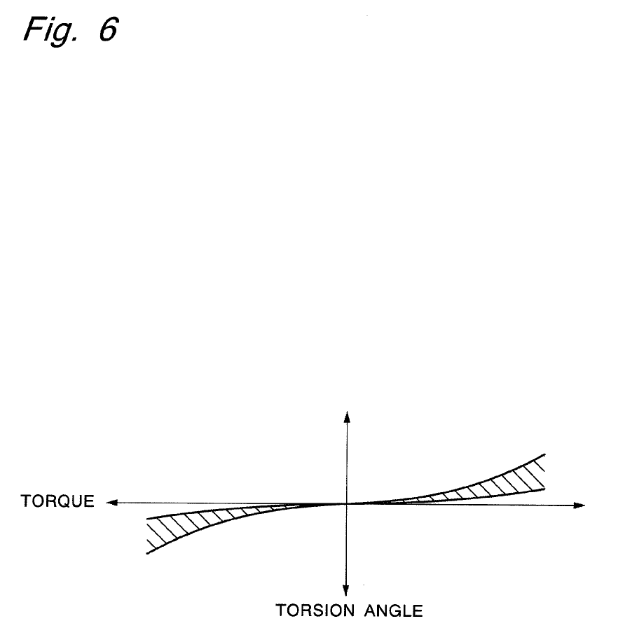

Therefore, as shown in FIG. 6, the biasing force adjustment mechanism 16 can adjust the torsion rigidity, which affects a torque for the torsion angle between the stabilizer bars 2 and 3, according to a running condition such as straight running and cornering running in the range indicated by the hatching in FIG. 6, by driving the screw member 18 to rotate by the electric motor 19 and adjusting the initial load of the coil spring 15.

The stabilizer device 1 according to the first embodiment is configured as mentioned above, and functions as follows.

When a vehicle advances straight, the vehicle body hardly rolls. Therefore, the torsion rigidity required to the stabilizer device 1 is small, and the stabilizer bars 2 and 3 can comparatively easily have respective independent rotations. As a result, for example, even if one of the wheels falls in a recess when the vehicle advances straight, it is possible to allow only the one wheel to have a stroke, and therefore possible to keep the stabilized running posture.

That is, when it is determined that a vehicle advances straight by detecting a running condition based on information such as a steering angle, an accelerator opening degree, a brake operation condition, and a lateral acceleration, the screw member 18 is rotated in an arbitrary direction by the electric motor 19, and the piston 17 is moved away from the second plate 12 so that the spring retainer 17A of the piston 17 is spaced apart from the second plate 12 by, for example, the large distance dimension G₁, as shown in FIG. 2. As a result, the initial load applied to the coil spring 15 is reduced, leading to a reduction in a torque which generates a torsion force required to cause a relative rotation between the first stabilizer bar 2 and the second stabilizer bar 3. Since the torsion rigidity of the stabilizer device 1 can be reduced, the left and right wheels each can have an independent stroke according to a rugged road, whereby an excellent ride comfort can be obtained.

On the other hand, when the driver turns the steering wheel to travel around a corner, an outward roll should be controlled. Therefore, the stabilizer device 1 rotates the screw member 18 in the opposite direction from the above-mentioned direction by the electric motor 19, causing the piston 17 to move toward the second plate 12 so that the spring retainer 17A of the piston 17 is spaced apart from the second plate 12 by, for example, the small distance dimension G₂, as shown in FIG. 3. As a result, the initial load applied to the coil spring 15 is increased, leading to an increase in a torsion force required to cause a relative rotation between the first stabilizer bar 2 and the second stabilizer bar 3. Since the torsion rigidity between the stabilizer bars 2 and 3 can be increased, the stabilizer device 1 can reduce an outward roll of the vehicle body, whereby the running posture can be stabilized at the time of cornering.

According to this control at the time of cornering, the initial load of the coil spring 15 is increased by the biasing force adjustment mechanism 16 regardless of whether the vehicle travels around a left corner or a right corner. Therefore, when the vehicle runs on a mountain road, and alternately travels around a left corner and a right corner like slaloming, once the torsion rigidity between the stabilizer bars 2 and 3 is increased, the torsion rigidity just has to be slightly adjusted according to a speed and a size of a corner, and frequent driving of electric motor 19 can be avoided.

Therefore, according to the first embodiment, it is possible to obtain the nonlinear characteristic due to the profile of the ramps 11 and 13, i.e., the circular arc shape, thereby improving a ride comfort. The variable rigidity unit 4, which couples the first stabilizer bar 2 and the second stabilizer bar 3 and adjusts the torsion rigidity, is constituted by the ball and ramp mechanism 9 which converts a relative rotation between the stabilizer bars 2 and 3 into a linear motion, the coil spring 15 which biases the second plate 12 of the ball and ramp mechanism 9 to reduce the linear motion, and the biasing force adjustment mechanism 16 which adjusts the biasing force of the coil spring 15.

Since the torsion rigidity adjustment by the variable rigidity unit 4 is an adjustment of increasing or reducing the biasing force (initial load) of the coil spring 15 by the biasing force adjustment mechanism 16, it is possible to provide the same control for a left corner and a right corner. As a result, even when there are successively alternately left corners and right corners, it is possible to prevent the electric motor 19 from being frequently driven. That is, it is possible to simplify the structure and the control by exerting the same control for a left corner and a right corner.

Further, in addition to providing the same control for a left corner and a right corner, the present embodiment employs the trapezoidal screw 17C, 18C for the linear motion conversion mechanism. Therefore, once the torsion rigidity between the stabilizer bars 2 and 3 is increased, the trapezoidal screw is retained at the controlled position, and the control does not have to be switched for a left corner and a right corner, whereby it is possible to further prevent the electric motor 19 from being frequently driven even when there are successively alternately left corners and right corners. As a result, it is possible to save electricity due to the reduction in the number of times of the adjustment operation, and miniaturize the stabilizer device 1 due to the simplification of the structure.

In addition, the ball and ramp mechanism 9 is constituted by the first plate 10 connected to the first stabilizer bar 2 and having the first ramps 11 formed thereon, the second plate 12 connected to the second stabilizer bar 3 and having the second ramps 13 formed thereon, and the balls 14 sandwiched between the first plate 10 and second plate 12 while being contained in the first ramps 11 and the second ramps 13. Therefore, the ball and ramp mechanism 9 can convert a relative rotation, which generates torsion between the stabilizer bars 2 and 3, into a linear motion by a simple structure, leading to simplification of the structure. As a result, the stabilizer device 1 can be miniaturized, and therefore can be attached to a vehicle body freely and conveniently according to a situation.

Further, the biasing force adjustment mechanism 16 is constituted by the piston 17 abutting against the coil spring 15, the screw member 18 screwed with the piston 17 to convert a rotation into a linear motion of the piston 17, and the electric motor 19 connected to the screw member 18. Therefore, the initial load of the coil spring 15 can be adjusted with use of the electric motor 19 which is easy to be controlled, leading to miniaturization of the stabilizer device 1 by the simplification of the structure and a reduction in the manufacturing cost.

Further, the ramps 11 and 13 of the plates 10 and 12 are formed into a circular arc groove the deepest portion 11A or 13A of which is located at the center in the extending direction and the depth of which is reduced from the deepest portion to the both ends. Therefore, it is possible to provide an excellent ride comfort by reducing the spring constant which affects a torque in the range where the torsion angle between the stabilizer bars 2 and 3 is small. On the other hand, it is possible to increase the torsion rigidity by increasing the spring constant in the range where the torsion angle between the stabilizer bars 2 and 3 is large, whereby it is possible to reduce a roll when a vehicle runs around a corner to stabilize the running posture.

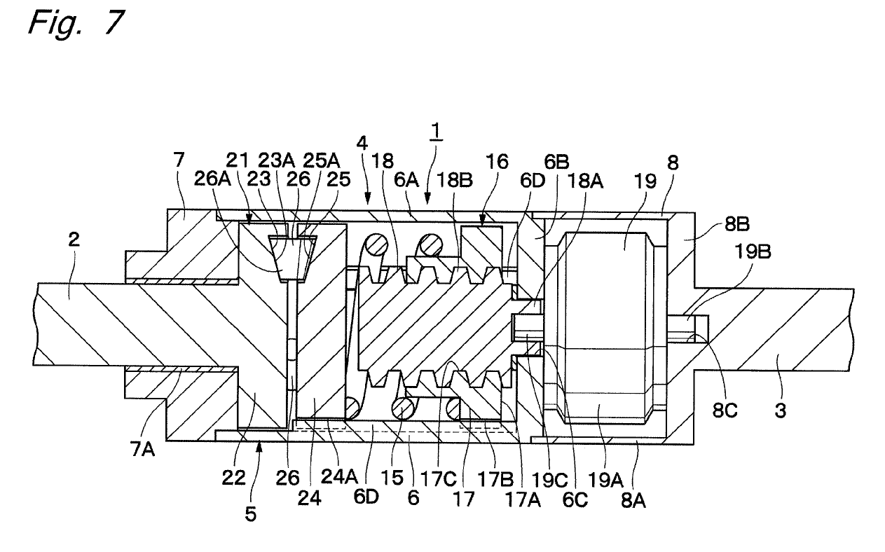

Next, FIG. 7 illustrates a second embodiment of the present invention. The present embodiment is characterized in that the rigidity adjustment mechanism is constituted by the first plate connected to the first stabilizer bar and having the first ramps formed thereon, the second plate connected to the second stabilizer bar and having second ramps formed thereon, and conical rollers sandwiched between the first plate and second plate while being contained in the first ramps and the second ramps. In the description of the present embodiment, like components will be denoted by like reference numerals as those in the above-discussed first embodiment, and the descriptions thereof will be omitted.

Referring to FIG. 7, reference numeral 21 denotes a rigidity adjustment mechanism as a linear motion mechanism according to the second embodiment. The rigidity adjustment mechanism 21 converts a relative rotation between the first stabilizer bar 2, and the second stabilizer bar 3 and the casing 5 into a linear motion, and is generally constituted by a first plate 22, a second plate 24, and conical rollers 26, as will be described later.

First ramps 23 according to the second embodiment are formed at the right end surface of the first plate 22 located within the plate case 6 and connected to the first stabilizer bar 2. Substantially similarly to the first ramps 11 according to the first embodiment, a plurality of ramps 23, for example, three ramps 23 are formed so as to define a circle. Each of the ramps 23 is formed into a circular arc groove the center of which in the extending direction (the circumferential direction of the plates 22 and 24) is deep, and the depth of which is reduced from the center to the both ends. However, the first ramp 23 according to the second embodiment is different from the first ramp 11 according to the first embodiment in terms that the first ramp 23 has a groove bottom 23A which is radially inclined so that the first ramp 23 is shallow on the center side of the first plate 22 and is deep at the outer circumferential side of the first plate 22.

Reference numeral 24 denotes a second plate disposed to face the first plate 22 at the right side of the first plate 22. Engagement grooves 24A, for example, three engagement grooves 24A are formed on the outer circumferential surface of the plate 24. The respective engagement grooves 24A are engaged with the respective protrusions 6D of the plate case 6. Further, a plurality of second ramps 25 according to the second embodiment, for example, three ramps 25 are formed on the left end surface of the second plate 24. Substantially similarly to the first ramps 23, each of the second ramps 25 is formed into a circular arc groove the center of which in the direction extending so as to define a circle is deep, and the depth of which is reduced from the center to the both ends. The second ramp 23 has a groove bottom 25A which is radially inclined so that the second ramp 25 is shallow on the center side of the second plate 24 and is deep at the outer circumferential side of the first plate 24.

Reference numeral 26 denotes three conical rollers sandwiched between the first plate 22 and the second plate 24. Each of the conical rollers 26 is contained in the first ramp 23 and the second ramp 25. The conical roller 26 is formed into a circular truncated cone so that the conical roller 26 has a small diameter at the center side where the travel distance is short, and a large diameter at the outer circumferential side where the travel distance is long so that the conical roller 26 rolls around the center of the plates 22 and 24. The outer circumferential surface of the conical roller 26 defines a tapered surface 26A rolling on the groove bottoms 23A and 25A of the ramps 23 and 25.

The second embodiment configured in this way can bring about advantageous effects substantially the same as those of the above-mentioned first embodiment. Especially, according to the second embodiment, the employment of the conical rollers 26 enables the stabilizer device 1 to endure a load heavier than that in the device employing the above-mentioned balls 14.

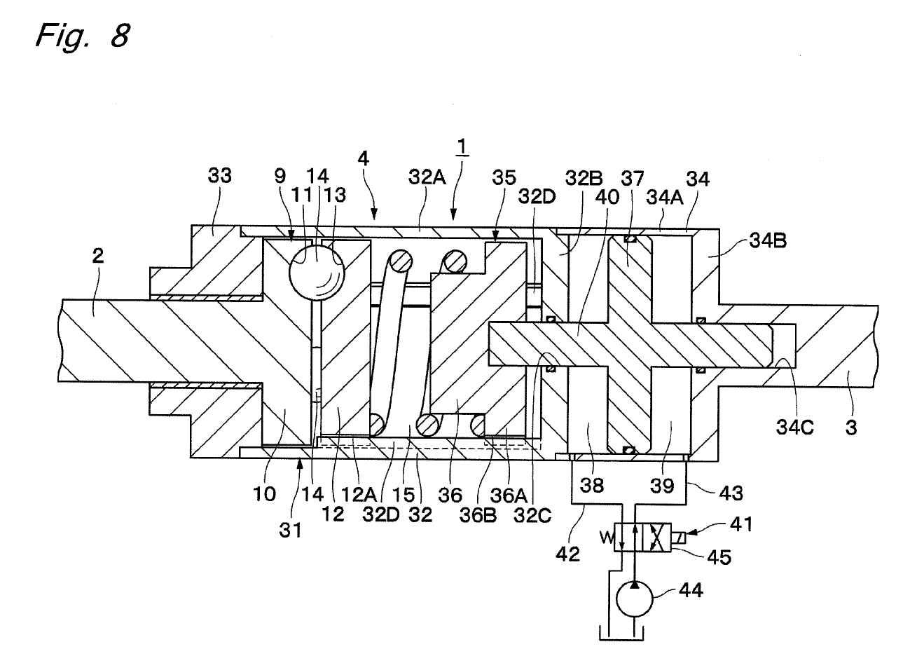

Next, FIG. 8 illustrates a third embodiment of the present invention. The present embodiment is characterized in that the biasing force adjustment mechanism (load application unit) thereof is constituted by the piston in abutment with the elastic member, and a pressure chamber disposed at the opposite side of the piston from the elastic member for pressing the piston by a supply of operating fluid. In the description of the present embodiment, like components will be denoted by like reference numerals as those in the above-discussed first embodiment, and the descriptions thereof will be omitted.

Referring to FIG. 8, a casing 31 according to the third embodiment is generally constituted by: a plate case 32 constituted by a cylindrical portion 32A, a bottom portion 32B, a shaft insertion hole 32C, and protrusions 32D; a cover body 33 integrally fixedly attached to the plate case 32 so as to close the opening of the cylindrical portion 32A of the plate case 32; and a cylinder case 34 disposed at the bottom portion 32B of the plate case 32.

The cylinder case 34 liquid-tightly contains a movable partition wall 37 which will be described later, and is formed into a bottomed cylindrical shape constituted by a cylindrical portion 34A and a bottom portion 34B. Further, the opening side of the cylindrical portion 34A is liquid-tightly fixedly attached to the outer circumferential side of the bottom portion 32B of the plate case 32. A support hole 34C is formed at the center of the bottom portion 34B for axially movably supporting a rod 40 which will be described later, in such a manner that the support hole 34C extends to reach the second stabilizer bar 3. The center of the bottom portion 34B is integrally connected to the proximal end of the second stabilizer bar 3.

Reference numeral 35 denotes a biasing force adjustment mechanism according to the third embodiment, which is disposed within the casing 31 for adjusting the biasing force of the coil spring 15. The biasing force adjustment mechanism 35 is configured as a load application unit for applying an arbitrarily-adjusted initial load in the extension/compression direction of the coil spring 15. Further, the biasing force adjustment mechanism 35 is generally constituted by a piston 36, which will be described later, contained in the plate case 32, the movable partition wall 37 disposed in the cylinder case 34, the pressure chambers 38 and 39, and a pressure oil supply/discharge mechanism 41 for supplying pressure oil into the pressure chambers 38 and 39.

Reference numeral 36 denotes a piston disposed to face the second plate 12 so as to sandwich the coil spring 15 between the piston 36 and the second plate 12. The piston 36 is formed into a stepped cylindrical shape. Further, the piston 36 has three engagement grooves 36B substantially equiangular formed on the outer circumferential surface of a large-diameter spring retainer 36A. The respective engagement grooves 36B are engaged with respective protrusions 32D of the plate case 32, whereby the piston 36 is axially movably connected to the casing 31 while being prevented from rotating relative to the casing 31.

Reference numeral 37 denotes a movable partition wall fittedly inserted in the cylinder case 34 so as to be axially movable. The movable partition wall 37 divides the interior of the cylinder case 34 into the left and right pressure chambers 38 and 39. Further, reference numeral 40 denotes a rod axially extending so as to penetrate the center of the movable partition wall 37. The rod 40 has one end side connected to the piston 36 through the shaft insertion hole 32C of the plate case 32, and the other end side inserted in the support hole 34C of the cylinder case 34. In this way, the cylinder case 34, the movable partition wall 37, the rod 40, and others constitute a hydraulic cylinder.

Reference numeral 41 denotes a pressure oil supply/discharge mechanism for supplying and discharging pressure oil into and from the pressure chambers 38 and 39. The pressure oil supply/discharge mechanism 41 is generally constituted by pipe lines 42 and 43 respectively connected to the pressure chambers 38 and 39, a hydraulic pump 44 for supplying pressure oil as operating fluid into the pressure chambers 38 and 39 through the pipe lines 42 and 43, and a supply/discharge control valve 45 for switching a supply destination of pressure oil supplied from the hydraulic pump 44.

The biasing force adjustment mechanism 35 configured in this way functions as follows. A supply of pressure oil from the pressure oil supply/discharge mechanism 41 into the right pressure chamber 39 causes the piston 36 to be linearly moved toward the second plate 12 through the movable partition wall 37 and the rod 40, thereby reducing the distance dimension between the second plate 12 and the spring retainer 36A of the piston 36. As a result, the initial load of the coil spring 15 can be adjusted to the large load side. On the other hand, a supply of pressure oil into the left pressure chamber 38 causes the piston 36 to be linearly moved away from the plate 12 through the movable partition wall 37 and the rod 40, thereby increasing the distance dimension between the second plate 12 and the spring retainer 36A of the piston 36. As a result, the initial load of the coil spring 15 can be adjusted to the small load side.

In this way, the third embodiment configured as mentioned above can also bring about advantageous effects substantially the same as those of the above-discussed first embodiment. Especially, according to the third embodiment, the biasing force adjustment mechanism 35, which serves as a load application unit, is generally constituted by the piston 36 in abutment with the coil spring 15, the movable partition wall 37 connected to the piston 36 through the rod 40, and the pressure chambers 38 and 39 for pressing the piston 36 through the movable partition wall 37 and the like by a supply of pressure oil thereto. Therefore, the torsion rigidity of the stabilizer device 1 can be adjusted by the hydraulic cylinder constituted by the cylinder case 34, the movable partition wall 37, the pressure chambers 38 and 39, the rod 40, and others.

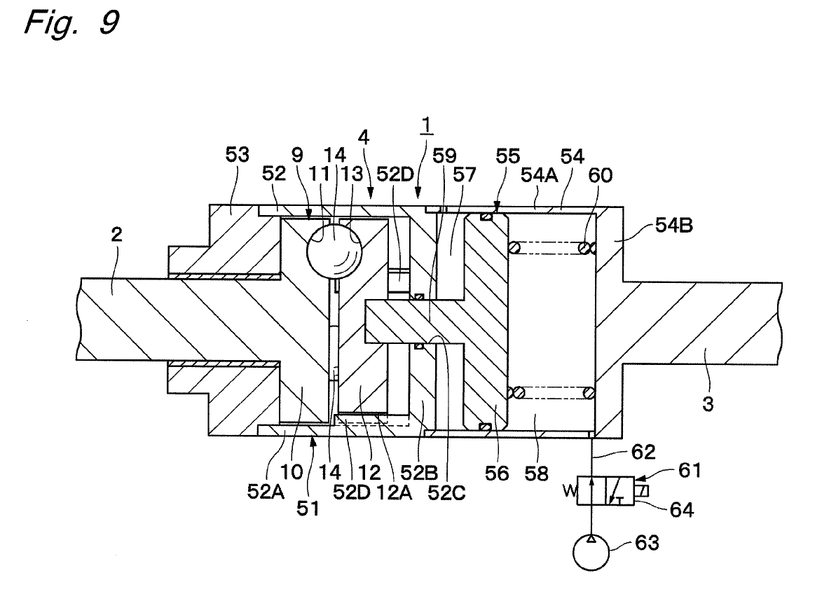

Next, FIG. 9 illustrates the fourth embodiment of the present invention. The present embodiment is characterized in that the load application unit is constituted by a pressure of supplied compressed air which is used as the elastic member, and a pressure chamber adjusting the biasing force of the elastic member by adjusting the pressure of the compressed air. In the description of the present embodiment, like components will be denoted by like reference numerals as those in the above-discussed first embodiment, and the descriptions thereof will be omitted.

Referring to FIG. 9, reference numeral 51 denotes a casing according to the fourth embodiment. The casing 51 is generally constituted by: a plate case 52 constituted by a cylindrical portion 52A, a bottom portion 52B, a shaft insertion hole 52C and protrusions 52D; a cover member 53 integrally fixedly attached to the plate case 52 so as to close the opening side of the cylindrical portion 52A of the plate case 52; and a cylinder case 54 disposed at the bottom portion 52B of the plate case 52.

Since the plate case 52 does not contain the coil spring 15 and the piston 17 discussed in the description of the first embodiment, the plate case 52 can have a significantly reduced axial dimension accordingly. Further, the cylinder case 54 air-tightly contains a movable partition wall 56 which will be described later, and is formed into a bottomed cylindrical shape constituted by the cylindrical portion 54A and the bottom portion 54B. Further, the opening side of the cylindrical portion 54A is air-tightly fixedly attached to the outer circumferential side of the bottom portion 52B of the plate case 52. The center of the bottom portion 54B is integrally connected to the proximal end of the second stabilizer bar 3.

Reference numeral 55 denotes a biasing force adjustment mechanism according to the fourth embodiment. The biasing force adjustment mechanism 55 serves as an elastic member for pressing the second plate 12 toward the first plate 10, and provides a desired initial load by adjusting the biasing force at this time. Further the biasing force adjustment mechanism 55 is generally constituted by the movable partition wall 56, which will be described later, contained in the cylinder case 54, a pressure chamber 58, a rod 59, and a compressed air supply/discharge mechanism 61 for supplying and discharging compressed air into and from the pressure chamber 58.

Reference numeral 56 denotes a movable partition wall fittedly inserted in the cylinder case 54 so as to be axially movable. The movable partition wall 56 divides the interior of the cylinder case 54 into an atmosphere open chamber 57 at the left side and a pressure chamber 58 at the right side. Further, reference numeral 59 denotes a rod axially extending from the center of the movable partition wall 56 toward the second plate 12. The tip of the rod 59 is connected to the second plate 12 through the shaft insertion hole 52C of the plate case 52. In this way, the cylinder case 54, the movable partition wall 56, the rod 59, and the others constitute a pneumatic cylinder.

Reference numeral 60 denotes a spring member disposed between the bottom portion 54B of the cylinder case 54 and the movable partition wall 56. The spring member 60 has a biasing force sufficient to cause the balls 14 to be positioned at the deepest portions 11A and 13A of the ramps 11 and 13 of the plates 10 and 12 even when the pressure chamber 58 is open to the atmosphere.

Reference numeral 61 denotes a compressed air supply/discharge mechanism for supplying and discharging compressed air into and from the pressure chamber 58. The compressed air supply/discharge mechanism 61 is generally constituted by a pipe line 62 connected to the pressure chamber 58, an air compressor 63 for supplying compressed air into the pressure chamber 58 through the pipe line 62, and a supply/discharge control valve 64 disposed at an intermediate position of the pipe line 62 for switching a connection destination of the pressure chamber 58 between the air compressor 63 and the atmosphere opening side.

The biasing force adjustment mechanism 55 configured in this way functions as follow. A supply of compressed air into the pressure chamber 58 by the compression air supply/discharge mechanism 61 enables adjustment of the initial load pressing the second plate 12 through the movable partition wall 56 and the rod 59 to the large load side. On the other hand, switching the supply/discharge valve 64 to make the pressure chamber 58 open to the atmosphere enables adjustment of the initial load pressing the second plate 12 to the small load side.

In this way, the fourth embodiment configured as mentioned above can also bring about advantageous effects substantially the same as those of the above-discussed first embodiment. Especially, according to the fourth embodiment, the pressure chamber 58 can be used as both an air spring and an elastic member by a supply of compressed air into the pressure chamber 58 of the biasing force adjustment mechanism 55. As a result, it is possible to omit the coil spring 15 and the piston 17 used in the first embodiment, leading to miniaturization of the stabilizer device 1.

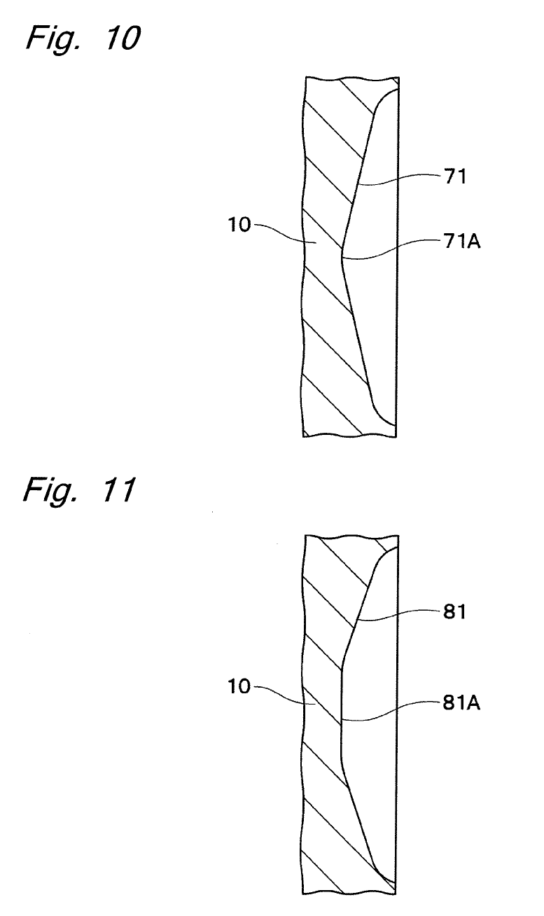

In the first embodiment, the ramps 11 and 13 each are formed into a circular arc groove the center of which in the extending direction is the deepest portion 11A or 13A and the depth of which is reduced from the center to the both ends. However, the present invention is not limited thereto. For example, like a ramp 71 according to a first variation shown in FIG. 10, the ramps may be formed into an inclined groove defining a V shape, the center of which in the extending direction is a deepest portion 71A and the depth of which is linearly reduced from the center to the both ends. This V-shaped ramp 71 can generate a torque proportionally to the torsion angle, and has excellent responsivity so that a change in the initial load can be quickly reflected to a behavior of the vehicle body.

Further, for example, like a ramp 81 according to a second variation shown in FIG. 11, a deepest portion 81A at the center may be flat. In this case, when the ball 14 rolls at the deepest portion 81A, no torque is generated, whereby a small undulation on a road is not transmitted to the vehicle body so that a ride comfort can be improved. These first and second variations can be employed to the other embodiments, too.

Further, the first embodiment includes three of the ramps 11 at the plate 10, three of the ramps 13 at the plate 12, and three balls 14 contained the ramps 11 and 13. However, the present invention is not limited thereto. For example, two ramps 11, two ramps 13, and two balls 14 may be provided, or four or more ramps 11, four or more ramps 13, and four or more balls 14 may be provided. These modifications may be employed to the other embodiments, too.

Further, in the first embodiment, the coil spring 15 is used as an elastic member for biasing the second plate 12 in the direction for preventing a linear motion. However, the present invention is not limited thereto. For example, another elastic member such as a disc spring or a rubber spring may be used. This modification may be applied to the other embodiments, too.

Further, in the first embodiment, the trapezoidal screw is used for the screw mechanism constituted by the female screw 17C of the piston 17 and the male screw 18B of the screw member 18. However, the present invention is not limited thereto. For example, another screw such as a ball screw may be used for the screw mechanism. This modification may be employed to the second embodiment, too. Now, a comparison is made between a stabilizer device employing a trapezoidal screw and a stabilizer device employing a ball screw. Because a trapezoidal screw has low reverse operability, once the trapezoidal screw is moved in the direction for increasing the rigidity, the characteristic can be maintained without consuming further electricity. However, when a failure occurs, the position of the piston is fixed so that the roll rigidity cannot be returned to the predetermined roll rigidity. On the other hand, a ball screw has high mechanical efficiency and excellent reverse operability, whereby a ball screw exerts soft characteristic when a failure occurs and the roll distribution between the front wheel side and the rear wheel side can be adjusted as desired. However, during a control, electricity should continue to be applied to the motor to maintain the piston position. A ball screw and a trapezoidal screw respectively have advantages and disadvantages, and may be selected as appropriate according to requirements.

Further, in the above-discussed embodiments, the first stabilizer bar and the second stabilizer bar have flexibility. However, the present invention is not limited thereto, and the stabilizer bars may be an extremely rigid member having substantially no flexibility. Therefore, the first stabilizer bar and the second stabilizer bar may be made from a light and rigid material.

As mentioned above, in the above-discussed embodiments, the variable rigidity unit, which couples the first stabilizer bar and the second stabilizer bar and adjusts the torsion rigidity, reduces or increases the biasing force of the biasing mechanism by means of the biasing force adjustment mechanism for adjustment of the torsion rigidity. Therefore, the same control is provided for a left corner and a right corner. As a result, a control for successive alternate left and right corners can be performed by increasing the torsion rigidity between the stabilizer bars just once. Therefore, for example, a power source such as an electric motor can be prevented from being frequently operated, and the structure can be simplified, leading to miniaturization of the stabilizer device.

Further, in some embodiments, the linear motion mechanism is constituted by the first plate with the first ramps formed thereon, the second plate with the second ramps formed thereon, and the balls contained in the first ramps and the second ramps. Therefore, no complicated structure is needed for conversion of a rotation into a linear motion, whereby the structure can be simplified. As a result, the stabilizer device can be miniaturized to become freely and conveniently attachable to the vehicle body.

Further, in other embodiments, the rigidity adjustment mechanism is constituted by the first plate with the first ramps thereof, the second plate with the second ramps formed thereon, and the conical rollers contained in the first ramps and second ramps. Therefore, no complicated structure is needed for conversion of a rotation into a linear motion, whereby the structure can be simplified. As a result, the stabilizer device can be miniaturized to become freely and conveniently attachable to the vehicle body. In addition, the employment of conical rollers enables the stabilizer device to endure a larger load.

Further, in some embodiments, the biasing force adjustment mechanism can convert a rotational motion into a linear motion with use of the screw mechanism, whereby a rotational actuator such as an electric motor can be employed as a drive source. As a result, the structure can be simplified and the manufacturing cost can be reduced.

Further, in some embodiments, a load can be applied to the elastic member through the piston by a supply of operating fluid into the pressure chamber. Therefore, the torsion rigidity can be adjusted by a simple structure.

Further, in some embodiments, the pressure chamber can be used as a pneumonic spring and an elastic member by a supply of compressed air into the pressure chamber of the biasing force adjustment mechanism, whereby the number of required parts can be reduced, leading to improved assemblability and miniaturization of the stabilizer device.

Further, the ramps are formed into a circular arc groove the center of which in the extending direction is deepest, and the depth thereof is reduced from the center to the both ends. Therefore, it is possible to provide an excellent ride comfort by reducing the spring constant which affects a torque in the range where the torsion angle between the stabilizer bars is small, while it is possible to increase the torsion rigidity by increasing the spring constant in the range where the torsion angle between the stabilizer bars is large, thereby reducing a roll when the vehicle travels around a corner to stabilize the running posture.

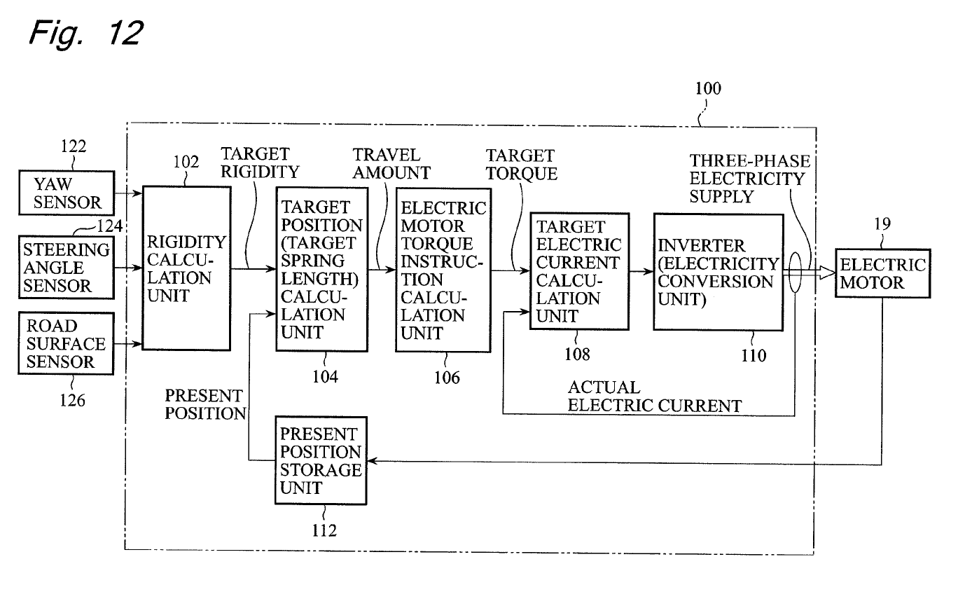

FIG. 12 is a block diagram illustrating a circuit configuration of the control device 100 shown in FIG. 1. How much a road where the vehicle runs is curved, i.e., a curvature of a road where the vehicle runs can be obtained based on an output of a sensor such as a yaw rate sensor 122 which measures a lateral acceleration. Similarly, how much a driver operates a steering wheel can be detected based on an output of a steering angle sensor 124 to obtain a curvature of a road where the vehicle runs. A flatness of a road surface can be detected based on an output of a road surface sensor 126. A rigidity calculation unit 102 of the control device 100 calculates target rigidity of the stabilizer 1 connected to the front wheels or the rear wheels based on outputs of the yaw rate sensor 122, the steering angle sensor 124, and the road surface sensor 126. The stabilizers 1 connected to the front wheels and rear wheels are controlled in a same manner, and therefore a control of one of them will be described on behalf of both of them.

A target position calculation unit 104 calculates a position of the piston 17 or the piston 36 to obtain the target rigidity based on the target rigidity calculated by the rigidity calculation unit 102. That is, an axial length of the biasing mechanism 15 is calculated. Since a position of the piston 17 or the piston 36 corresponds to a rotational position of the rotator of the electric motor 19, a position of the piston 17 or the piston 36 can be detected from an output of a resolver for detecting a magnetic pole position which is a position of the rotator of the electric motor 19. The detected rotational position of the rotator of the electric motor 19, the position of the piston 17 or the piston 36, or the axial length of the biasing mechanism 15 is stored in a present position storage unit 112. The target position calculation unit 104 calculates and obtains a travel amount, i.e., a rotational direction and a travel amount of a rotation of the rotator of the electric motor 19 based on a signal indicating the present position from the present position storage unit 112 and the target rigidity calculated by the rigidity calculation unit 102.

A torque instruction calculation unit 106 of the electric motor 19 calculates a target rotational torque based on the travel amount calculated by the target position calculation unit 104. If the travel amount calculated by the target position calculation unit 104 is zero, i.e., the target position coincides with the present position, application of holding current to the electric motor 19 is unnecessary for maintaining the rotational position, because in the above-mentioned embodiments, the rotation/linear motion conversion mechanism has the function of holding the axial length of the biasing mechanism 15 with the aid of a mechanical frictional force. A target electric current calculation unit 108 calculates an electric current value to be applied to the electric motor 19 based on the target rotational torque calculated by the torque instruction calculation unit 106. An alternating current is supplied to the electric motor 19 based on the calculated target electric current value by controlling an inverter 110 which converts a direct current to an alternating current. A feedback control of an electric current value supplied to the motor can be performed based on an output of an electric current sensor for detecting an electric current value. The present rotational position of the electric motor 19 can be detected from, for example, an output of the resolver, and is stored in the present position storage unit.

When the vehicle runs on a gentle curve, the gentleness of the curve is detected by the yaw rate sensor 122 or the steering angle sensor 124, and then the rigidity calculation unit 102 calculates low target rigidity. As a result, the electric motor 19 is controlled so that the axial length of the coil spring 15 which is the biasing mechanism is increased. Further, if it is detected that a road surface is rugged based on an output of the road surface sensor 126, low target rigidity is set to damp rattling of the vehicle body. Accordingly, the electric motor 19 is controlled so that the axial length of the coil spring 15 is increased, and then the pressing force to the ball and ramp mechanism is reduced and the resistance is reduced. As a result, the rigidity of the stabilizer device is reduced. On the other hand, if a road surface is hardly rugged, i.e., a road surface is smooth, high target rigidity is set. Accordingly, the axial length of the coil spring 15 is reduced, the pressing force to the ball and ramp mechanism is increased, and the resistance of the ball and ramp mechanism is increased. As a result, the rigidity of the stabilizer device is increased.

As mentioned above, the rigidity characteristic of the stabilizer device can be optimally adjusted by controlling a rotational amount of the electric motor. Further, in the above-mentioned control, if a travel amount based on the calculation of the target position calculation unit 104 is less than a predetermined value, an electric current value supplied to the electric motor 19 can be extremely reduced, or zero can be set as the electric current value. As a result, electricity consumption can be reduced.

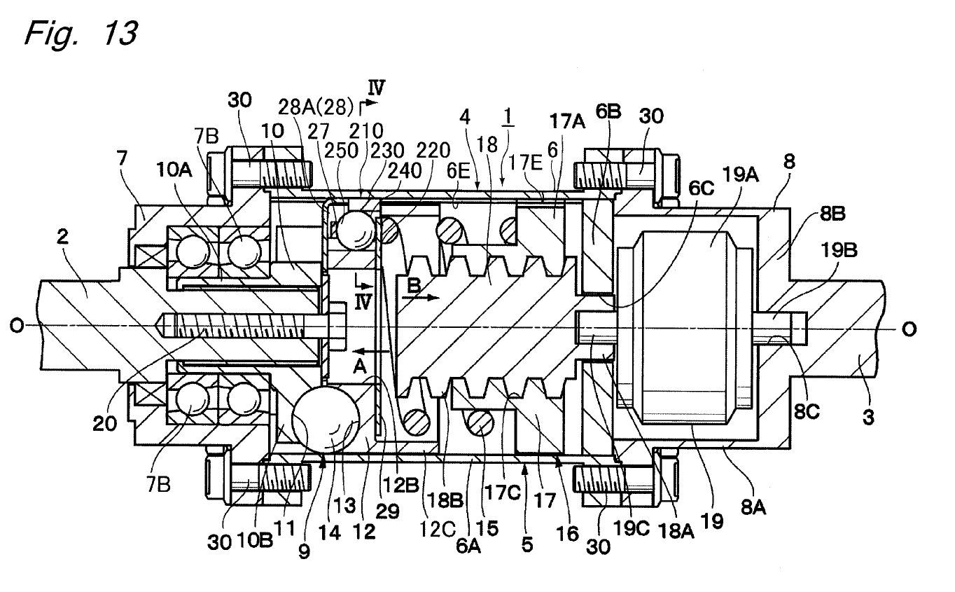

Next, FIGS. 13 to 15 illustrate a fifth embodiment of the present invention. The present embodiment is characterized in that the second plate 12 non-rotatably coupled to the casing 5 is configured as a rotation prevention mechanism for reducing frictional resistance. In the description of the present embodiment, like components will be denoted by like reference numerals as those in the above-discussed first embodiment, and the descriptions thereof will be omitted.

The cover body 7 disposed at an axial one side (left end side as viewed in FIG. 2) of the casing 5 has a stepped cylindrical shape, and is fixedly attached to the left side of the plate case 6 by, for example, fastening bolts 30 which will be described later so as to close the left end of the cylindrical portion 6A. Further, two bearings 7B such as a pair of angular ball bearings are disposed at the inner circumferential side of the cover body 7. The bearings 7B rotatably support the first stabilizer bar 2 with the first plate 10, which will be described later, in the cover body 7, and receives an axial thrust load acting on the first plate 10 with the cover body 7.

Further, the opening side of the cylindrical portion 8A is fixedly attached to the cylindrical portion 6A of the plate case 6 with use of, for example, the fastening bolts 30 which will be described later. The shaft fixation hole 8C, through which the fixation shaft 19B of the electric motor 19 is non-rotatably fittedly inserted, is formed at the center of the bottom portion 8B.

The casing 5 not only contains the ball and ramp mechanism 9 as a linear motion mechanism and the coil spring 15 (biasing mechanism for applying a thrust force to the linear motion mechanism) which will be described later, but also serves as a transmission member for transmitting a torsion force, i.e., a torsion torque. Therefore, the structure of the stabilizer device 1 can be simplified. The casing 5 of the variable rigidity unit 4 has a structure effective for simplification of the structure of the stabilizer device 1.

The ball and ramp mechanism 9 is constituted by the first plate 10 which integrally rotates with the first stabilizer bar 2, the second plate 12 disposed in the plate case 6 so as to axially face the first plate 10, the balls 14 each disposed between the plates 10 and 12 as a rolling member of a rigid material rollable along the groove shape of the ramps 11 and 13, and rolling linear motion guides 210 as rotation prevention mechanisms which will be described later. The rolling member is not limited to the spherical ball 14, and may be embodied by any rollable member such as a conical roller.

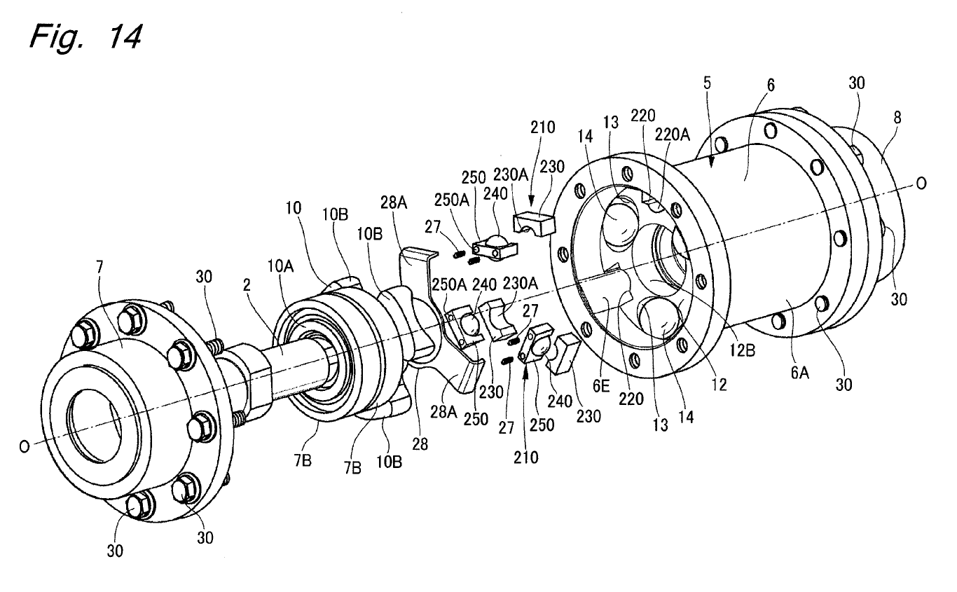

As shown FIGS. 13 to 15, the first plate 10 disposed at the left portion of the plate case 6 includes a fitting cylindrical portion 10A axially extending along the axis O-O, and three sector arms 10B radially outwardly protruding from the right end of the fitting cylindrical portion 10A in a circumferentially spaced-apart relationship. As shown in FIG. 14, the sector arms 10B are formed into a substantially fan-shaped plate. The sector arms 10B of the first plate 10 are disposed at such positions that they are circumferentially staggered relative to spring retaining portions 28A of a retainer 28 which will be described later.

The proximal end of the first stabilizer bar 2 is coupled in the fitting cylindrical portion 10A of the first plate 10 with use of a rotation prevention means such as a spline. While in this state, the first plate 10 is fixed to the first stabilizer bar 2 by means of, for example, a bolt 20 which will be described later. Therefore, the first plate 10 can integrally rotate with the first stabilizer bar 2 relative to the second stabilizer bar 3.

Further, the first ramps 11 as first inclinations, for example, three of the ramps 11 in total are formed on the right end surfaces (front surfaces) of the sector arms 10B of the first plate 10 so as to extend in the circumferential direction of the plate 10. The ramps 11 formed at the sector arms 108 each are formed into a recessed inclined groove curved like a circular arc. Further, the ramp 11 is formed into a circular arc groove as an inclination the center of which in the extending direction is the deepest and the depth of which is reduced from the deepest portion to the both ends according to a desired curvature.

On the other hand, as shown FIGS. 13 and 14, the second plate 12 disposed at the right of the first plate 10 so as to face the first plate 10 is formed into a thick circular disk the center of which is located on the axis O-O, and has an extending cylindrical portion 12C axially extending from the outer circumferential side of the second plate 12. The extending cylindrical portion 12C surrounds the left portion of the coil spring 15, which will be described later, from the radially outer side to protect the coil spring 15 from the outside, and guides the coil spring 15 so that the biasing force of the coil spring 15 can stably act on the second plate 12. Further, an axial through-hole 12B is formed at the inner circumferential side of the second plate 12 for an insertion of, for example, the bolt 20 which will be described later, with a gap generated therebetween.

As shown in FIGS. 13 to 15, the rolling linear motion guides 210, which will be described later, are disposed at the outer circumferential side of the second plate 12 so as to be substantially equiangular located. Guide pieces 230 of the rolling linear motion guides 210 are disposed so as to be engaged with rotation prevention grooves 6E of the plate case 6. The second plate 12 is prevented from rotating relative to the casing 5 in the casing 5 by the rolling linear motion guides 210 which will be described later, and therefore the second plate 12 can smoothly move in the axial direction in the casing 5.

The three second ramps 13 as second inclinations are formed on the left end surface (front surface) of the second plate 12 facing the first plate 10. Substantially similarly to the first ramp 11, the three ramps 13 each are formed into a curved shape like a circular arc, and are formed as a circular arc groove as an inclination the center of which in the extending direction is the deepest, and the depth of which is reduced from the deepest portion to the both ends.

The first and second ramps 11 and 13 can adjust a ride comfort of the vehicle due to their groove shape (curved shape). That is, it is desirable to reduce influence on a ride comfort by reducing the biasing force of the coil spring 15, which will be described later, in the range where the torsion angle between the first plate 10 and the second plate 12 is small, and to reduce a roll at the time of cornering by increasing the biasing force of the coil spring 15 in the range where the torsion angle is large.

To create this desirable arrangement, the groove shape of the first and second ramps 11 and 13 is a circular arc having a large curvature radius so as to hardly generate a torsion force in the range where the torsion angle between the first plate 10 and the second plate 12 is small, and has a small curvature radius so as to rapidly increase a torque in the range where the torsion angle is large. Such a nonlinear characteristic can be adjusted based on the shape of the groove. Alternately, the shape and profile of the groove of the ramps 11 and 13 may be determined according to a desired characteristic by, for example, combining a linear shape and a curved shape.

The three balls 14 sandwiched between the sector arms 10B of the first plate 10 and the second plate 12 are contained between the first ramps 11 and the second ramps 13. Further, the balls 14 each are formed into, for example, a metal ball having an outer diameter sized such that the sector arms 10B of the first plate 10 and the second plate 12 does not contact each other while the balls 14 are contained between the ramps 11 and 13.

In the ball and ramp mechanism 9 configured in this way, the balls 14 are normally disposed at the deepest portions of the ramps 11 and 13 by pressing of the first plate 10 and the second plate 12 toward each other by means of the biasing force of the coil spring 15 which will be described later. As a result, the first stabilizer bar 2 and the second stabilizer bar 3 are biased to be constantly retained at an initial angle (the angle not generating an inclination of the vehicle) by means of the biasing force of the coil spring 15 which will be described later.

On the other hand, when there is a relative rotation between the first stabilizer bar 2 and the second stabilizer bar 3 (casing 5) about the axis O-O, the balls 14 are moved from the center to the end sides of the first ramps 11 and second ramps 13, since the first ramps 11 and the second ramps 13 are circumferentially relatively out of alignment with each other. This movement of the balls 14 causes the plates 10 and 12 to be axially displaced away from each other according to the inclination of the ramps 11 and 13. In this case, increasing the biasing force of the coil spring 15 pressing the second plate 12 toward the first plate 10 by the biasing force adjustment mechanism 16, which will be described later, can increase the torsion rigidity at this time.

The coil spring 15, as the biasing mechanism disposed at the right side of the second plate 12 and contained in the plate case 6, biases the second plate 12 in the direction for preventing a linear motion of the second plate 12, and is constituted only by an elastic member generating a pressing force for pressing the second plate 12 toward the first plate 10. Employment of the coil spring 15 as the elastic member enables the elastic member to be formed from one member, and improves assemblability compared to, for example, employment of a plurality of disc springs.

The biasing force adjustment mechanism 16, which is disposed in the casing 5 for adjusting the biasing force of the coil spring 15, is configured as a load application unit for applying an arbitrarily-adjusted initial load in the extension/compression direction of the coil spring 15. Further, the biasing force adjustment mechanism 16 is generally constituted by the piston 17 as a movement means disposed in the plate case 6, the screw member 18, the electric motor 19 as a driving means disposed in the motor case 8, and the control device 100 (refer to FIG. 1) such as a controller.

The electric motor 19 is contained in the motor case 8, and is aligned with the ball and ramp mechanism 9, the piston 17 which will be describe later, and the screw member 18 in the axial direction. However, the present invention is not limited thereto. For example, if the axial length of the casing 5 is limited, the electric motor as a driving means may be arranged in parallel with the screw member 18, and the screw member 18 may be driven to rotate through a power transmission mechanism constituted by, for example, a plurality of gears.

As shown in FIG. 13, the piston 17 as a movement means is formed into a stepped cylindrical shape, and is disposed to face the second plate 12 so as to sandwich the coil spring 15 between the piston 17 and the second plate 12. Further, the piston 17 includes the large-diameter spring retainer 17A as an annular collar radially outwardly protruding from the axial one end (right end) side of the piston 17. Further, three engagement protrusions 17E are equiangularly formed at the outer circumferential side of the spring retainer 17A. The respective engagement protrusions 17E are engaged with the respective rotation prevention grooves 6E of the plate case 6, whereby the piston 17 is coupled in such a manner that the piston 17 is axially movable while being prevented from rotating relative to the casing 5.

Further, the female screw 17C embodied by, for example, a trapezoidal screw, is formed on the inner circumferential side of the piston 17. The female screw 17C, along with the male screw 18B of the screw member 18 which will be described later, constitutes a screw mechanism as a linear motion conversion mechanism for converting a rotation of the electric motor 19, which will be described later, into a linear motion of the piston 17.

The screw member 18 disposed to be screwed with the inner circumference side of the piston 17 is attached at the shaft attachment portion 18A at the proximal side thereof to the output shaft 19C of the electric motor 19, whereby the shaft attachment portion 18A integrally rotates with the output shaft 19C. Further, the male screw 18B, which is embodied by a trapezoidal screw screwed with the female screw 17C of the piston 17, is formed at the outer circumferential side of the screw member 18. The male screw 18B, along with the female screw 17C, constitutes the screw mechanism.

The piston 17 is screwed with the screw member 18 through the female screw 17C and the male screw 18B embodied by a trapezoidal screw. Therefore, the piston 17 is neither displaced in the direction indicated by the arrow A nor the direction indicated by the arrow B in FIG. 13 as long as the screw member 18 is not driven to rotate by the electric motor 19, and the piston 17 does not move in the axial direction (the directions indicated by the arrows A and B in FIG. 2) by the biasing force of the coil spring 15.

The electric motor 19 as a driving means is generally constituted by the main body 19A containing, for example, the stator and the rotator (both are not shown), the fixation shaft 19B protruding from the right end of the main body 19A and non-rotatably fittedly inserted in the shaft fixation hole 8C of the motor case 8, and the output shaft 19C protruding from the left end of the main body 19A and connected to the rotator. Further, the output shaft 19C is fittedly inserted in the shaft attachment portion 18A of the screw member 18 within the shaft insertion hole 6C of the plate case 6 so that the output shaft 19C integrally rotates with the screw attachment portion 18A.

As shown in FIG. 13, in the biasing force adjustment mechanism 16 configured in this way, the initial load of the coil spring 15 is determined by the distance dimension between the second plate 12 and the spring retainer 17A of the piston 17. In this case, driving the screw member 18 to rotate by the electric motor 19 to linearly move the piston 17 toward the second plate 12 (the direction indicated by the arrow A in FIG. 13) enables the distance dimension between the second plate 12 and the spring retainer 17A of the piston 17 to be reduced, and thereby the initial load of the coil spring 15 to be adjusted to the large load side.

On the other hand, driving the screw member 18 in the reverse direction by the electric motor 19 to move the piston 17 away from the second plate 12 (in the direction indicated by the arrow B in FIG. 13) enables the distance dimension between the second plate 12 and the spring retainer 17A of the piston 17 to be increased, and thereby the initial load of the coil spring 15 to be adjusted to the small load side.

Therefore, as indicated by the characteristic line 31 in FIG. 6, the biasing force adjustment mechanism 16 variably adjusts the torque as the torsion rigidity to the torsion angle between the stabilizer bars 2 and 3 by driving the screw member 18 to rotate with use of the electric motor 19 and adjusting the initial load of the coil spring 15. That is, the torque to the torsion angle between the stabilizer bars 2 and 3 is variably adjusted in the range indicated by hatching in FIG. 6 according to a running condition such as straight running or cornering running. Therefore, adjustment of the initial load of the coil spring 15 does not change the fact that a force acts for the torsion angle 0 between the stabilizer bars 2 and 3.

The three rolling linear motion guides 210 as a rotation preventing mechanisms in total are disposed between the cylindrical portion 6A of the casing 5 (plate case 6) and the second plate 12 in a circumferentially spaced-apart relationship. The rolling linear motion guides 210 are equiangularly disposed at different positions from the ramps 13 in the circumferential direction of the second plate 12. These rolling linear motion guides 210 prevent the second plate 12 from having a relative rotation within the cylindrical portion 6A of the plate case 6, and ensure a smooth axial displacement of the second plate 12 within the cylindrical portion 6A.

As shown in FIGS. 13 to 15, the rolling linear motion guide 210 is constituted by a plate-side guide groove 220 configured as a substantially U-shaped concaved groove radially facing the rotation prevention groove 6E of the plate case 6 and formed so as to be open to the cylinder portion 6A at the outer circumferential side of the second plate 12, the guide piece 230 as a casing-side guide member fixedly disposed at the inner circumferential side of the plate case 6 to be slidably fitted in the plate-side guide groove 220, a spherical body 240 as an axially rolling element rollably disposed between the guide piece 230 and the plate-side guide groove 220, a holder 250 rollably holding the spherical body 240 between the plate-side guide groove 220 and the guide piece 230, springs 27 as biasing members biasing the spherical body 240 along with the holder 250 toward a spherical body containing space 260 as a roller containing space defined between the plate-side guide groove 220 and the guide piece 230, and a retainer 28 which will be described later.

As shown in FIG. 13, the plate-side guide groove 220 extends in the axial direction of the second plate 12, whereby the extending cylindrical portion 12C has a partial cutout. Further, a groove portion 220A having a circular arc shape is formed at the bottom side of the plate-side guide groove 220 so as to have a slightly larger curvature than the outer diameter of the spherical body 240. As shown in FIG. 14, the groove portion 220A extends in the axial direction of the second plate 12.

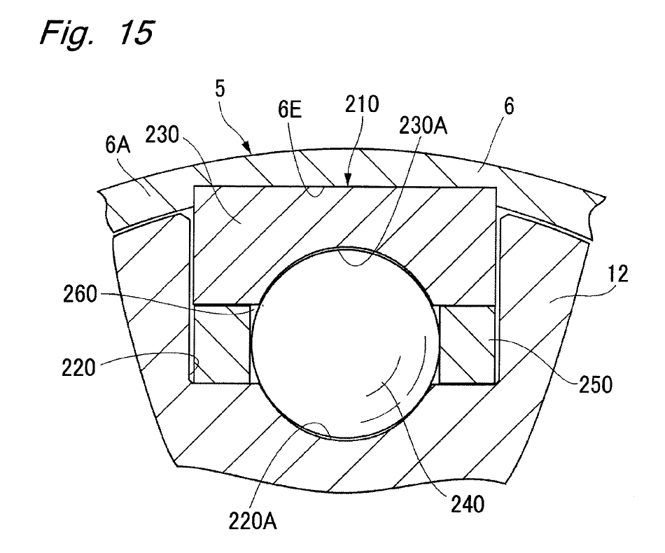

As shown in FIG. 15, the guide piece 230 is fitted to the rotation prevention groove 6E of the plate case 6 by, for example, the press-fitting method, and is securely fixed to the inner circumferential side of the plate case 6. Further, the guide pieces 230 includes a circular arc groove portion 230A having a slightly larger curvature than the outer diameter of the spherical body 240 at a position radially opposite of the spherical body 240 from the groove portion 220A of the plate-side guide groove 220. The groove portion 230A is formed into a concaved groove extending in the axial direction of the guide piece 230.

The spherical body 240 rolls between the two groove portions 220A and 230A while being sandwiched therebetween, and reduces frictional resistance generated when the second plate 12 of the groove portion 220A side is axially moved relative to the guide piece 230 of the groove portion 230A side. That is, the spherical body 240 as an axial rolling element ensures a smooth axial movement of the second plate 12 in the cylindrical portion 6A of the casing 5 (plate case 6).

In this case, as shown in FIG. 14, the holder 250 is formed as a substantially U-shaped small part. As shown in FIG. 14, the holder 250 is disposed between the plate-side guide groove 220 and the guide piece 230 while rollably holding the spherical body 240 therein. The holder 250 serves as a fall-out prevention member for preventing the spherical body 240 from falling from the space between the groove portions 220A and 230A to the outside. Further, the holder 250 serves to maintain the initial position.

A plurality of circular shallow groove portions 250A (for example, two portions) is formed at the end of the holder 250 at such positions that the shallow groove portions 250A face the spring retaining portion 28A of the retainer 28. A spring 27 is disposed between each shallow groove 250A and each spring retaining portion 28A of the retainer 28 for biasing the spherical body 240 toward a washer 29 (refer to FIG. 13) with a sufficiently smaller biasing force than that of the coil spring 15.

The washer 29 is constituted by an annular flat plate abutting against or fixed to the end surface of the second plate 12 in the extending cylindrical portion 12c, and receives the biasing force of the coil spring 15 with the second plate 12. The washer 29 cooperates with the holders 250 to prevent the spherical bodies 240 from falling out from the spherical body containing spaces 260 defined between the plate-side guide groove 220 and the guide piece 230 to the outside. Therefore, the holders 250 and the washer 290 are arranged at such positions that they sandwich the spherical bodies 240 in the spherical body containing spaces 260 from the front and rear (both axial sides).

The retainer 28 is a backup member disposed so as to be sandwiched between the first plate 10 and the second plate 12 for supporting the springs 27 serving as biasing members from the back face side thereof. As shown in FIG. 14, the retainer 28 includes three spring retaining portions 28A in total which radially outwardly extend. The springs 27 are disposed between the spring retaining portions 28A and the shallow groove portions 250A of the respective holders 250 in a preset state (pre-compressed state). In other words, the springs 27 are disposed in such a state that they constantly provide a set load to the spherical bodies 240. Therefore, the springs 27 bias the spherical bodies 240 into the spherical body containing spaces 260 with the holders 250.

Further, the spring retaining portions 28A of the retainer 28 are disposed in a staggered relationship with the sector arms 10B of the first plate 10 in the circumferential direction of the casing 5 so that the spring retaining portions 28A are out of axial alignment with the sector arms 10B. Therefore, the spherical bodies 240 in the three rolling linear motion guides 210 are located in a staggered relationship with the spherical bodies 14 of the ball and ramp mechanism 9 in the circumferential direction of the casing 5, and they are equiangularly arranged.

Further, a plurality of fastening bolts 30 is disposed in a circumferentially spaced-apart relationship along the outer circumferential side of the casing 5. That is, the cover body 7 located at the left side as viewed in FIG. 13 is flange-coupled to the left end side of the plate case 6 (cylindrical portion 6A) with use of, for example, the fastening bolts 30. Further, the cylindrical portion 8A of the motor case 8 is flange-coupled to the right end side of the plate case 6 (cylindrical portion 6A) with use of, for example, the fastening bolts 30.

The stabilizer device 1 according to the fifth embodiment is configured as mentioned above, and functions as follows.

When a vehicle advances straight, the vehicle body hardly rolls. Therefore, the torsion rigidity required to the stabilizer device 1 is small, and the stabilizer bars 2 and 3 can comparatively easily have respective independent rotations. As a result, for example, even if one of the wheels falls in a recess when the vehicle advances straight, it is possible to allow only the one wheel to have a stroke, and therefore possible to keep the stabilized running posture.

That is, when it is determined that a vehicle advances straight (a driver does not turn a steering wheel in a manner causing a large roll) by detecting a running condition based on information such as a steering angle, an accelerator opening degree, a brake operation condition, and a lateral acceleration, the screw member 18 is rotated in a predetermined direction by the electric motor 19, and the piston 17 is moved away from the second plate 12 so that the spring retainer 17A of the piston 17 is spaced apart from the second plate 12 by a comparatively long distance dimension, as shown in FIG. 13.

As a result, the initial load applied to the coil spring 15 is reduced, leading to a reduction in a torque which generates a torsion force required to cause a relative rotation between the first stabilizer bar 2 and the second stabilizer bar 3. Since the torsion rigidity of the stabilizer device 1 can be reduced, the left and right wheels each can have an independent stroke according to a rugged road, whereby an excellent ride comfort can be obtained.

On the other hand, when the driver turns the steering wheel to travel around a corner, an outward roll should be controlled. Therefore, the stabilizer device 1 rotates the screw member 18 in the opposite direction from the above-mentioned direction by the electric motor 19, causing the piston 17 to move in the direction indicated by the arrow A in FIG. 13 so that the spring retainer 17A of the piston 17 is spaced apart from the second plate 12 by a short distance dimension.

As a result, the initial load applied to the coil spring 15 is increased, leading to an increase in a torsion force required to cause a relative rotation between the first stabilizer bar 2 and the second stabilizer bar 3. Since the torsion rigidity between the stabilizer bars 2 and 3 can be increased, the stabilizer device 1 can reduce an outward roll of the vehicle body, whereby the running posture of the vehicle can be stabilized at the time of, for example, cornering.

According to this control at the time of cornering, the initial load (spring force) of the coil spring 15 is increased by the biasing force adjustment mechanism 16 regardless of whether the vehicle travels around a left corner or a right corner. Therefore, when a vehicle runs on a mountain road, and alternately travels around left corners and right corners like slaloming, once the torsion rigidity between the stabilizer bars 2 and 3 is increased, the torsion rigidity just has to be slightly adjusted according to a speed and a size of a corner, and frequent driving of electric motor 19 can be unnecessitated.

In this way, when it is determined that a vehicle is in a roll running condition causing a relatively large roll based on information such as a steering angle, an accelerator opening degree, a brake operation condition, and a lateral acceleration and information from a car navigation system, the initial load (spring force) of the coil spring 15 is increased by the biasing force adjustment mechanism 16 while the vehicle is in the roll running condition. Then, when straight running of the vehicle is continued for a predetermined time, the initial load (spring force) of the coil spring 15 may be reduced.

Therefore, according to the fifth embodiment, it is possible to obtain the nonlinear characteristic due to the profile of the ramps 11 and 13, i.e., the circular arc shape of the grooves, thereby improving a ride comfort.

The variable rigidity unit 4, which couples the first stabilizer bar 2 and the second stabilizer bar 3 and adjusts the torsion rigidity therebetween, is constituted by the ball and ramp mechanism 9 which converts a relative rotation between the stabilizer bars 2 and 3 into a linear motion, the coil spring 15 which axially biases the second plate 12 of the ball and ramp mechanism 9 toward the first plate 10 to reduce the linear motion, and the biasing force adjustment mechanism 16 which adjusts the biasing force of the coil spring 15.

Since the torsion rigidity adjustment by the variable rigidity unit 4 is an adjustment of increasing or reducing the biasing force of the coil spring 15 by the biasing force adjustment mechanism 16, it is possible to provide the same control for a left corner and a right corner.

As a result, even when there are successively alternately left corners and right corners, the variable rigidity unit 4 only has to increase the torsion rigidity between the stabilizer bars 2 and 3 once, since the female screw 17C and the male screw 18B embodied by a trapezoidal screw are formed between the piston 17 and the screw member 18 of the biasing force adjustment mechanism 16, whereby frequent driving of the electric motor 19 can be unnecessitated. Therefore, it is possible to save electricity due to the reduction in the number of times of the adjustment operation and miniaturize the stabilizer device 1 due to the simplification of the structure.

Further, the ball and ramp mechanism 9 is constituted by the first plate 10 connected to the first stabilizer bar 2 and having the first ramps 11 formed thereon, the second plate 12 connected to the second stabilizer bar 3 and having the second ramps 13 formed thereon, the three balls 14 in total sandwiched between the first plate 10 and second plate 12 while being contained in the first ramps 11 and the second ramps 13, and the three rolling linear motion guides 210 disposed between the casing 5 and the second plate 12 in a staggered relationship with the balls 14.

Therefore, the ball and ramp mechanism 9 can convert a relative rotation, which generates torsion between the stabilizer bars 2 and 3, into a linear motion by a simple structure, leading to simplification of the structure. As a result, the stabilizer device 1 can be miniaturized, and therefore becomes attachable to a vehicle body freely and conveniently according to a situation.

Especially, as shown in FIGS. 13 to 15, the rolling linear motion guide 210 is constituted by the plate-side guide groove 220 configured as a substantially U-shaped concaved groove radially facing the rotation prevention groove 6E of the plate case 6 at the outer circumferential side of the second plate 12, the guide piece 230 having the outer circumferential side press-fitted in the rotation prevention groove 6E of the plate case 6 and the inner circumferential side slidably fitted in the plate-side guide groove 220, the spherical body 240 axially rollably disposed between the guide piece 230 and the plate-side guide groove 220 through the groove portions 220A and 230A, the holder 250 rollably holding the spherical body 240 between the plate-side guide groove 220 and the guide piece 230, and the springs 27 biasing the spherical body 240 toward the spherical body containing space 260 defined between the plate-side guide groove 220 and the guide piece 230.

In this way, the three rolling linear motion guides 210 in total are disposed in a circumferentially spaced-apart relationship between the cylindrical portion 6A of the casing 5 (plate case 6) and the second plate 12, whereby it is possible to prevent the second plate 12 from having a relative rotation within the cylindrical portion 6A of the plate case 6, and ensure a smooth axial displacement of the second plate 12 within the cylindrical portion 6A.

More specifically, when the ball and ramp mechanism 9 converts a relative rotation between the stabilizer bars 2 and 3 into a linear motion, the second plate 12 is moved away from the first plate 10 (in the direction indicated by the arrow B in FIG. 2) according to the relative rotation between the first plate 10 and the second plate 12. At this time, the spherical bodies 240 of the rolling linear motion guides 210 roll between the groove portions 220A of the plate-side guide grooves 220 and the groove portions 230A of the guide pieces 230 in the axial direction (in the direction indicated by the arrow B in FIG. 2), thereby reducing frictional resistance generated between the plate-side guide grooves 220 and the guide pieces 230.

Further, when there is a relative rotation between the stabilizer bars 2 and 3 in the direction for eliminating torsion therebetween, the second plate 12 is moved toward the first plate 10 (in the direction indicated by the arrow A in FIG. 13) by the biasing force of the coil spring 15. Therefore, the spherical bodies 240 of the rolling linear motion guides 210 roll between the groove portions 220A of the plate-side guide grooves 220 and the groove portions 230A of the guide pieces 230 in the axial direction (in the direction indicated by the arrow A in FIG. 13), thereby reducing frictional resistance generated between the plate-side guide grooves 220 and the guide pieces 230.

At this time, the spherical bodies 240 are contained in the spherical body containing spaces 260 between the plate-side guide grooves 220 and the guide pieces 230 with the aid of the washer 29, and are moved back to be held between the holders 250 and the washer 29 by the biasing force of the springs 27. The springs 27 bias the spherical bodies 240 in the direction indicated by the arrow B through the holders 250, and thereby prevent the spherical bodies 240 from moving between the groove portions 220A and the 230A due to an inertial force generated by the movement of the vehicle body when no torque is generated between the stabilizer bars 2 and 3 (no frictional force acts on the spherical bodies 240), and ensures that the spherical bodies 240 constantly start to roll (operate) from a predetermined initial position (for example, the position shown in FIG. 13), whereby a required stroke can be stably obtained with a minimized space.

As a result, when the ball and ramp mechanism 9 converts a relative rotation between the stabilizer bars 2 and 3 to a linear motion, even if a large torque is generated between the cylindrical portion 6A of the casing 5 and the second plate 12, frictional resistance generated between the plate-side guide grooves 220 and the guide pieces 230 can be reduced by rolling of the spherical bodies 240, thereby preventing, for example occurrence of hysteresis, leading to realization of a small and low-resistive linear motion guide.

Further, the three rolling linear motion guides 210 in total are equiangularly disposed at different positions from those of the ramps 13 in the circumferential direction of the second plate 12. Therefore, the plates 10 and 12 of the ball and ramp mechanism 9 are prevented from becoming larger which would otherwise occur due to the addition of the rolling linear motion guides 210, whereby the outer diameters thereof can be minimized. When the second plate 12 is moved away from the first plate 10 when the stabilizer device 1 operates, the spherical bodies 240 of the rolling linear motion guides 210 roll in such a manner that the spherical bodies 240 partially protrude between the plates 10 and 12, and the spaces defined among the three balls 14 in the circumferential direction can be effectively utilized as spaces for the spherical bodies 240.

Further, the biasing force adjustment mechanism 16 is constituted by the piston 17 abutting against the coil spring 15, the screw member 18 screwed with the piston 17 to convert a rotation into a linear motion of the piston 17, the electric motor 19 connected to the screw member 18, and the control device 100 such as a controller. Therefore, the initial load of the coil spring 15 can be adjusted with use of the electric motor 19 which is easy to be controlled, leading to miniaturization of the stabilizer device 1 by the simplification of the structure and a reduction in the manufacturing cost.

Further, the ramps 11 and 13 formed on the plates 10 and 12 are formed into a circular arc groove the deepest portion of which is located at the center in the extending direction and the depth of which is reduced from the deepest portion to the both ends. Therefore, it is possible to provide an excellent ride comfort by reducing the spring load of the coil spring 15 which affects a torque in the range where the torsion angle between the stabilizer bars 2 and 3 is small. On the other hand, it is possible to increase the torsion rigidity by increasing the spring load of the coil spring 15 in the range where the torsion angle between the stabilizer bars 2 and 3 is large, whereby it is possible to reduce a roll when a vehicle runs around a corner to stabilize the running posture. Cylindrical rollers may be employed as axial rolling elements of the rotation prevention mechanisms.

Further, in the fifth embodiment, the guide pieces 230 as the casing-side guide member are fitted into the rotation prevention grooves 6E of the plate case 6 by, for example, the press-fitting method, and fixed to the inner circumferential side of the plate case 6. However, the present invention is not limited thereto. For example, the casing-side guide member may be integrally formed at the inner circumferential side of the casing constituted by the plate case 6 and others. Further, the rolling linear motion guides 210 according to the fifth embodiment can be employed to any of the first to fourth embodiments, too.

Further, the above-discussed embodiments include the three ramps 11 at the plate 10, the three ramps 13 at the plate 12, and the three balls 14 contained in the ramps 11 and 13 of the ball and ramp mechanism 9. However, the present invention is not limited thereto. For example, two ramps 11, two ramps 13, and two balls 14 may be provided, or four or more ramps 11, four or more ramps 13, and four or more balls 14 may be provided. Similarly, two or four or more rolling linear motion guides 210 as the rotation prevention mechanisms may be provided in a circumferentially staggered relationship with the balls 14.

An aspect of the present invention according to the above-discussed fifth embodiment has the following advantageous. The plurality of rotation prevention mechanisms is disposed at different positions from those of the second inclinations (ramps) in the circumferential direction of the second plate. Therefore, the first and second plates 10 and 12 of the linear motion mechanism are prevented from becoming larger which would otherwise occur due to the addition of the rotation prevention mechanisms, whereby the outer diameters thereof can be miniaturized. When the second plate is moved away from the first plate when the stabilizer device operates, the axial rolling elements of the rotation prevention mechanisms can roll in such a manner that the axial rolling elements partially protrude between the first and second plates, and the spaces defined among the rolling members of the linear motion mechanism in the circumferential direction can be effectively utilized as spaces for the axial rolling elements.

Especially, due to the equiangular arrangement of the rotation prevention mechanisms in the circumferential direction of the second plate, the spaces defined among the rolling members of the linear motion mechanism in the circumferential direction can be more effectively utilized as spaces for the axial rolling elements.

According to the above-discussed embodiments of the present invention, the stabilizer device can be miniaturized.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The entire disclosure of Japanese Patent Application No. 2009-179707 filed on Jul. 31, 2009 and Japanese Patent Application No. 2009-271822 filed on Nov. 30, 2009 including specification, claims, drawings and summary is incorporated herein by reference in its entirety.

What is claimed is:

1. A stabilizer device comprising:
a first stabilizer bar;
a second stabilizer bar; and
a variable rigidity unit coupling the stabilizer bars and adjusting torsion rigidity,
the variable rigidity unit comprising
a linear motion mechanism adapted to perform a linear motion according to a relative rotation between the first stabilizer bar and the second stabilizer bar,
a biasing mechanism for biasing the linear motion mechanism in a direction for preventing the linear motion, and
a biasing force adjustment mechanism for adjusting a biasing force of the biasing mechanism.

2. The stabilizer device according to claim 1, wherein:
the linear motion mechanism comprises
a first plate coupled with the first stabilizer bar and including a circumferentially extending first inclination formed on a surface thereof,
a second plate coupled with the second stabilizer bar and disposed in a such a manner that a surface thereof faces the first plate, the second plate including a circumferentially extending second inclination formed on the surface thereof, and
a ball or conical roller sandwiched between the first inclination and the second inclination;
the biasing mechanism comprises an elastic member for generating a pressing force for pressing the first plate and the second plate against each other; and
the biasing force adjustment mechanism comprises a load application unit for applying a load to the elastic member.

3. The stabilizer device according to claim 2, wherein the load application unit comprises
a piston adapted to abut against the elastic member;
a linear motion conversion mechanism for converting a rotation into a linear motion of the piston, and
a rotation actuator coupled with the linear motion conversion mechanism.

4. The stabilizer device according to claim 2, wherein the load application unit comprises
a piston adapted to abut against the elastic member, and
a pressure chamber disposed opposite of the piston from the elastic member, the pressure chamber operable to press the piston by a supply of operating fluid.

5. The stabilizer device according to claim 2, wherein the load application unit comprises a pressure chamber adapted to serve as the elastic member by a pressure of supplied compressed air, and also serves to adjust the biasing force of the elastic member by adjusting the pressure of the compressed air.

6. The stabilizer device according to claim 2, wherein the inclinations each are formed into an inclined groove the center of which in an extending direction thereof is the deepest and the depth of which is reduced toward the both ends thereof.

7. The stabilizer device according to claim 3, wherein the inclinations each are formed into an inclined groove the center of which in an extending direction thereof is the deepest and the depth of which is reduced toward the both ends thereof.

8. The stabilizer device according to claim 4, wherein the inclinations each are formed into an inclined groove the center of which in an extending direction thereof is the deepest and the depth of which is reduced toward the both ends thereof.

9. The stabilizer device according to claim 5, wherein the inclinations each are formed into an inclined groove the center of which in an extending direction thereof is the deepest and the depth of which is reduced toward the both ends thereof.

10. The stabilizer device according to claim 2, wherein:
the variable rigidity unit is disposed in a cylindrical casing;
a rotation prevention mechanism is disposed between the casing and the second plate for allowing an axial displacement of the second plate in the casing while preventing a relative rotation therebetween; and
the rotation prevention mechanism comprises
a plate-side guide groove disposed at the second plate to be open to the casing,
a casing-side guide member disposed in the casing to be engaged with the plate-side guide groove, the casing-side guide member defining a roller containing space between the plate-side guide groove and the casing-side guide member,
an axially rolling element rollably disposed between the casing-side guide member and the plate-side guide groove so as to be axially rollable in the roller containing space, and
a biasing member for axially biasing the axially rolling element in the roller containing space.

11. The stabilizer device according to claim 3, wherein:
the variable rigidity unit is disposed in a cylindrical casing;
a rotation prevention mechanism is disposed between the casing and the second plate for allowing an axial displacement of the second plate in the casing while preventing a relative rotation therebetween; and
the rotation prevention mechanism comprises
a plate-side guide groove disposed at the second plate to be open to the casing,
a casing-side guide member disposed in the casing to be engaged with the plate-side guide groove, the casing-side guide member defining a roller containing space between the plate-side guide groove and the casing-side guide member,
an axially rolling element rollably disposed between the casing-side guide member and the plate-side guide groove so as to be axially rollable in the roller containing space, and
a biasing member for axially biasing the axially rolling element in the roller containing space.

12. The stabilizer device according to claim 4, wherein:
the variable rigidity unit is disposed in a cylindrical casing;
a rotation prevention mechanism is disposed between the casing and the second plate for allowing an axial displacement of the second plate in the casing while preventing a relative rotation therebetween; and
the rotation prevention mechanism comprises
a plate-side guide groove disposed at the second plate to be open to the casing,
a casing-side guide member disposed in the casing to be engaged with the plate-side guide groove, the casing-side guide member defining a roller containing space between the plate-side guide groove and the casing-side guide member,
an axially rolling element rollably disposed between the casing-side guide member and the plate-side guide groove so as to be axially rollable in the roller containing space, and
a biasing member for axially biasing the axially rolling element in the roller containing space.

13. The stabilizer device according to claim 5, wherein:
the variable rigidity unit is disposed in a cylindrical casing;
a rotation prevention mechanism is disposed between the casing and the second plate for allowing an axial displacement of the second plate in the casing while preventing a relative rotation therebetween; and
the rotation prevention mechanism comprises
a plate-side guide groove disposed at the second plate to be open to the casing,
a casing-side guide member disposed in the casing to be engaged with the plate-side guide groove, the casing-side guide member defining a roller containing space between the plate-side guide groove and the casing-side guide member,
an axially rolling element rollably disposed between the casing-side guide member and the plate-side guide groove so as to be axially rollable in the roller containing space, and
a biasing member for axially biasing the axially rolling element in the roller containing space.

14. The stabilizer device according to claim 6, wherein:
the variable rigidity unit is disposed in a cylindrical casing;
a rotation prevention mechanism is disposed between the casing and the second plate for allowing an axial displacement of the second plate in the casing while preventing a relative rotation therebetween; and
the rotation prevention mechanism comprises
a plate-side guide groove disposed at the second plate to be open to the casing,
a casing-side guide member disposed in the casing to be engaged with the plate-side guide groove, the casing-side guide member defining a roller containing space between the plate-side guide groove and the casing-side guide member,
an axially rolling element rollably disposed between the casing-side guide member and the plate-side guide groove so as to be axially rollable in the roller containing space, and
a biasing member for axially biasing the axially rolling element in the roller containing space.

15. The stabilizer device according to claim 7, wherein:
the variable rigidity unit is disposed in a cylindrical casing;
a rotation prevention mechanism is disposed between the casing and the second plate for allowing an axial displacement of the second plate in the casing while preventing a relative rotation therebetween; and
the rotation prevention mechanism comprises
a plate-side guide groove disposed at the second plate to be open to the casing,
a casing-side guide member disposed in the casing to be engaged with the plate-side guide groove, the casing-side guide member defining a roller containing space between the plate-side guide groove and the casing-side guide member,
an axially rolling element rollably disposed between the casing-side guide member and the plate-side guide groove so as to be axially rollable in the roller containing space, and
a biasing member for axially biasing the axially rolling element in the roller containing space.

16. The stabilizer device according to claim 8, wherein:
the variable rigidity unit is disposed in a cylindrical casing;
a rotation prevention mechanism is disposed between the casing and the second plate for allowing an axial displacement of the second plate in the casing while preventing a relative rotation therebetween; and
the rotation prevention mechanism comprises
a plate-side guide groove disposed at the second plate to be open to the casing,
a casing-side guide member disposed in the casing to be engaged with the plate-side guide groove, the casing-side guide member defining a roller containing space between the plate-side guide groove and the casing-side guide member,
an axially rolling element rollably disposed between the casing-side guide member and the plate-side guide groove so as to be axially rollable in the roller containing space, and
a biasing member for axially biasing the axially rolling element in the roller containing space.

17. The stabilizer device according to claim 9, wherein:
the variable rigidity unit is disposed in a cylindrical casing;
a rotation prevention mechanism is disposed between the casing and the second plate for allowing an axial displacement of the second plate in the casing while preventing a relative rotation therebetween; and
the rotation prevention mechanism comprises
a plate-side guide groove disposed at the second plate to be open to the casing,
a casing-side guide member disposed in the casing to be engaged with the plate-side guide groove, the casing-side guide member defining a roller containing space between the plate-side guide groove and the casing-side guide member,
an axially rolling element rollably disposed between the casing-side guide member and the plate-side guide groove so as to be axially rollable in the roller containing space, and
a biasing member for axially biasing the axially rolling element in the roller containing space.

18. A stabilizer device comprising:
a first stabilizer bar;
a second stabilizer bar;
a variable rigidity unit coupling the stabilizer bars and adjusting torsion rigidity,
the variable rigidity unit comprising
a linear motion mechanism adapted to perform a linear motion according to a relative rotation between the first stabilizer bar and the second stabilizer bar,
a biasing mechanism for biasing the linear motion mechanism in a direction for preventing the linear motion, and
a biasing force adjustment mechanism for adjusting a biasing force of the biasing mechanism,
the linear motion mechanism comprising
a first plate coupled with the first stabilizer bar and including a circumferentially extending first inclination formed on the surface thereof,
a second plate coupled with the second stabilizer bar and disposed in such a manner that the surface thereof faces the first plate, the second plate including a circumferentially extending second inclination formed on the surface thereof, and
a ball or a conical roller sandwiched between the first inclination and the second inclination,
the biasing mechanism comprising an elastic member for generating a pressing force for pressing the first plate and the second plate against each other,
the biasing force adjustment mechanism comprising a load application unit for providing a load to the elastic member,
the variable rigidity unit being disposed in a cylindrical casing; and
a rotation prevention mechanism being disposed between the casing and the second plate for allowing an axial displacement of the second plate in the casing while preventing a relative rotation therebetween,
the rotation prevention mechanism comprising
a plate-side guide groove formed at the second plate so as to be open to the casing,
a casing-side guide member disposed at the casing so as to be engaged with the plate-side guide groove, the casing-side guide member defining a roller containing space between the plate-side guide groove and the casing-side guide member,
an axially rolling element rollably disposed between the casing-side guide member and the plate-side guide groove to be axially rollable in the roller containing space, and
a biasing member for axially biasing the axially rolling element in the roller containing space.
